(19) United States
(12) Patent Application Publication
(10) Pub. No.: US 2024/0243809 A1
(43) Pub. Date: Jul. 18, 2024

(54) OPTICAL WIRELESS COMMUNICATION METHOD AND DEVICE

(71) Applicant: HUAWEI TECHNOLOGIES CO., LTD., Shenzhen (CN)

(72) Inventors: Jingjing HUANG, Shenzhen (CN); Junping ZHANG, Shenzhen (CN)

(21) Appl. No.: 18/620,555

(22) Filed: Mar. 28, 2024

Related U.S. Application Data
(63) Continuation of application No. PCT/CN2022/119316, filed on Sep. 16, 2022.

(30) Foreign Application Priority Data
Sep. 30, 2021 (CN) 202111165946.X

(51) Int. Cl. H04B 10/116

(52) U.S. Cl. CPC H04B 10/116

(57) ABSTRACT

The present disclosure relates to optical wireless communication methods and devices. In one example method, a first communication device receives optical signals separately transmitted by N nodes, and obtains, based on the received optical signals of the N nodes, first parameters that are of the N nodes and that are used to locate the first communication device and an information bit stream corresponding to each node. The optical signals are obtained by the nodes by performing electrical-to-optical conversion on a first signal, the first signal is a signal obtained by adding a direct current bias signal to a second signal, and the second signal is a signal obtained after constant envelope modulation is performed on an information bit stream to be sent by a light source node to the first communication device.

### CROSS-REFERENCE TO RELATED APPLICATIONS

This application is a continuation of International Application No. PCT/CN2022/119316, filed on Sep. 16, 2022, which claims priority to Chinese Patent Application No. 202111165946.X, filed on Sep. 30, 2021. The disclosures of the aforementioned applications are hereby incorporated by reference in their entireties.

### TECHNICAL FIELD

This application relates to the field of optical wireless communication technologies, and in particular, to an optical wireless communication method and a device.

### BACKGROUND

Wireless communication systems are gradually developing towards millimeter waves, such as electromagnetic waves in terahertz frequency bands and optical frequency bands, and using the millimeter waves for wireless communication is studied. For example, in a light fidelity (light fidelity, Li-Fi) technology, the millimeter wave (for example, visible light) is used for communication. The Li-Fi technology may be referred to as a visible optical communication (visible light communication, VLC) technology.

However, the VLC technology can only implement positioning or communication, and cannot implement positioning and communication at the same time. In other words, the VLC technology-based positioning technology cannot be well integrated with the wireless communication.

### SUMMARY

Embodiments of this application provide an optical wireless communication method and a device, to implement device positioning and inter-device communication at the same time by using an optical wireless communication technology.

To achieve the foregoing objectives, the following technical solutions are used in embodiments of this application.

According to a first aspect, an embodiment of this application provides an optical communication method. The method may include: A first communication device receives optical signals separately transmitted by N nodes; and obtains, based on the received optical signals of the N nodes, first parameters that are of the N nodes and that are used to locate the first communication device and an information bit stream corresponding to each node. The optical signals are obtained by the nodes by performing electrical-to-optical conversion on first signals, the first signal is a signal obtained by adding a direct current bias signal to a second signal, the second signal is a signal obtained after constant envelope modulation is performed on an information bit stream to be sent by a light source node to the first communication device, and different nodes correspond to different frequencies of carriers used for constant envelope modulation, to distinguish information bit streams sent by different nodes; and N is an integer greater than or equal to 3.

Based on the method according to the first aspect, a plurality of nodes use constant envelope modulation, and signals transmitted by a single node have a same spectral shape. The first communication device receives optical signals transmitted by a group of (at least three) nodes (such as LEDs), converts the optical signals into electrical signals through optical-to-electrical conversion, processes the electrical signals to obtain spectrums of the signals, compares, based on the spectrums of the signals, center frequencies of the signals with center frequencies of locally stored carriers, determines the nodes that transmit the signals, obtains location information of the nodes (the location information of the nodes is known to first user equipment), calculates power attenuation percentages of the signals, obtains horizontal distances between the first communication device and each node based on the power attenuation percentages, then calculates location information of the first communication device based on a positioning method, and obtains, through filtering, information bit streams transmitted on corresponding communication frequencies by the first communication device and the nodes.

In a possible design, for a first node, the first node is any one of the N nodes, and that the first communication device obtains a horizontal distance d between the first node and the first communication device and location information of the first node includes: The first communication device performs optical-to-electrical conversion processing on a received first optical signal to obtain a third signal, where the third signal is a signal obtained after the first signal is transmitted through a channel, and the first optical signal is any optical signal received by the first communication device; the first communication device compares a center frequency of a spectrum of the third signal with a center frequency of a carrier corresponding to each node, and if the center frequency of the spectrum of the third signal is the same as a center frequency of a carrier corresponding to the first node, determines that the first optical signal from the first node is received; and the first communication device determines a power attenuation percentage based on a receive power of the third signal and a transmit power used when the first node transmits the optical signal, determines the horizontal distance d between the first communication device and the first node based on the power attenuation percentage, and obtains the location information of the first node according to a stored correspondence between a node and location information of the node.

Based on this possible design, the signals being received from which nodes may be identified by comparing spectrums, so that the first communication device is located based on locations of the nodes and corresponding power attenuation percentages, and information bit streams are obtained through demodulation, thereby implementing an integrated design of positioning and information transmission.

In a possible design, that a first communication device receives optical signals separately transmitted by N nodes includes: The first communication device receives, on receive frequencies of the nodes, the optical signals transmitted by the nodes, where receive frequencies of different nodes are different from each other, to ensure that spectrums of signals transmitted by the different nodes do not overlap, and avoid interference.

In a possible design, the method further includes: The first communication device sends, on an access channel, an access request to a second communication device, where the access request includes the current location information of the first communication device and an identifier of the first communication device; the first communication device receives, on the access channel, an access response from the second communication device, where the access response includes the identifier of the first communication device and a communication frequency of each of the N nodes; and the first communication device accesses the N nodes in response to the access response. Based on this possible design, the nodes may be accessed to implement optical wireless communication with the nodes.

In a possible design, the method further includes: The first communication device receives, on the access channel, fixed bit streams from M nodes, and determines the current location information of the first communication device based on the fixed bit streams of the M nodes, where M is an integer greater than or equal to 3. Based on this possible design, positioning may be implemented based on fixed bit streams sent by a plurality of nodes.

In a possible design, the N nodes are nodes that are close to the first communication device and whose channels are idle in nodes around the first communication device, to ensure quality of communication between the N nodes and the first communication device.

In a possible design, the method further includes: The first communication device detects that quality of a channel between the first node and the first communication device is lower than a preset threshold, where the first node is included in the N nodes; the first communication device sends, on the access channel, a switching request to the second communication device, where the switching request includes the current location information of the first communication device and the identifier of the first communication device; the first communication device receives, on the access channel, a switching response from the second communication device, where the switching response includes the identifier of the first communication device and a communication frequency of a second node; and the first communication device switches from the first node to the second node in response to the switching response. Based on this possible design, switching may be performed in time when signal quality is poor, to ensure communication quality.

In a possible design, the second node is a node that is close to the first communication device and whose channel is idle in the nodes around the first communication device, to ensure quality of communication between the second node and the first communication device after the first communication switches to the second node.

According to a second aspect, this application provides a communication apparatus. The communication apparatus may be a first communication device or a chip or a system-on-a-chip in the first communication device, or may be a functional module that is in the first communication device and that is configured to implement the method according to any one of the first aspect or the possible designs of the first aspect. Alternatively, the communication apparatus may be an access network device, a chip or a system-on-a-chip in the access network device, or may be a functional module that is in the access network device and that is configured to implement the method according to any one of the second aspect or the possible designs of the second aspect. The communication apparatus may implement functions performed by the first communication device or the access network device in the foregoing aspects or the possible designs, and the functions may be implemented by hardware executing corresponding software. The hardware or the software includes one or more modules corresponding to the functions. For example, the communication apparatus may include a transceiver unit and a processing unit.

The transceiver unit is configured to receive optical signals separately transmitted by N nodes, where the optical signals are obtained by the nodes by performing electrical-to-optical conversion on first signals, the first signal is a signal obtained by adding a direct current bias signal to a second signal, the second signal is a signal obtained after constant envelope modulation is performed on an information bit stream to be sent by a light source node to the first communication device, different nodes correspond to different frequencies of carriers used for constant envelope modulation, and N is an integer greater than or equal to 3.

The processing unit is configured to obtain, based on the received optical signals of the N nodes, first parameters of the N nodes and an information bit stream corresponding to each node, where the first parameters include horizontal distances d between the nodes and the first communication device and location information of the nodes, and the first parameters of the N nodes are used to determine current location information of the first communication device.

Specifically, for an action performed by each unit of the communication apparatus, refer to the description in any one of the first aspect or the possible designs of the first aspect. Details are not described again.

According to a third aspect, a communication apparatus is provided. The communication apparatus may be a first communication device, or a chip or a system-on-a-chip in the first communication device. The communication apparatus may implement functions performed by the first communication device in the foregoing aspects or the possible designs, and the functions may be implemented by hardware. Alternatively, the communication apparatus may be an access network device, or a chip or a system-on-a-chip in the access network device. The communication apparatus may implement functions performed by the access network device in the foregoing aspects or the possible designs, and the functions may be implemented by hardware. In a possible design, the communication apparatus may include a processor and a communication interface. The processor and the communication interface may support the communication apparatus to perform the method according to any one of the first aspect or the possible designs of the first aspect. In another possible design, the communication apparatus may further include a memory, and the memory is configured to store computer-executable instructions and data that are necessary for the communication apparatus. When the communication apparatus runs, the processor executes the computer-executable instructions stored in the memory, so that the communication apparatus performs the optical communication method according to any one of the first aspect or the possible designs of the first aspect.

According to a fourth aspect, a computer-readable storage medium is provided. The computer-readable storage medium may be a readable nonvolatile storage medium, and the computer-readable storage medium stores instructions. When the instructions are run on a computer, the computer is enabled to perform the communication method according to any one of the first aspect or the possible designs of the first aspect.

According to a fifth aspect, a computer program product that includes instructions is provided. When the computer program product is run on a computer, the computer is enabled to perform the optical communication method according to any one of the first aspect or the possible designs of the first aspect.

According to a sixth aspect, a communication apparatus is provided. The communication apparatus may be a first communication device, or a chip or a system-on-a-chip in the first communication device. The communication apparatus includes one or more processors and one or more memories. The one or more memories are coupled to the one or more processors. The one or more memories are configured to store computer program code. The computer program code includes computer instructions, and when the one or more processors execute the computer instructions, the first communication device is enabled to perform the method according to any one of the first aspect or the possible designs of the first aspect.

For technical effects achieved by any one of the design manners of the third aspect to the sixth aspect, refer to technical effects achieved by any one of the first aspect or the possible designs of the first aspect. Details are not described again.

According to a seventh aspect, an embodiment of this application provides a communication system. The communication system may include a first communication device, N nodes, and a second communication device. The first communication device may perform the optical communication method according to any one of the first aspect or the possible designs of the first aspect.

### BRIEF DESCRIPTION OF DRAWINGS

FIG. 1 is a schematic diagram of an electromagnetic spectrum;

FIG. 2 is a schematic diagram of a Li-Fi technology;

FIG. 3 is a schematic diagram of advantages of a Li-Fi technology;

FIG. 4 is a schematic diagram of a positioning principle of a plurality of light sources;

FIG. 5 is a schematic diagram of RSS-based positioning;

FIG. 6 is a schematic diagram of a process in which an LED light source emits light and a PD receives the light;

FIG. 7 is a curve diagram of a relationship between a received signal strength and a horizontal distance;

FIG. 8 is a schematic diagram of a terminal provided with an ALS;

FIG. 9 is a schematic diagram of ALS-based positioning;

FIG. 10 is a schematic diagram of an architecture of an LED-based wireless optical communication system;

FIG. 11 is a schematic diagram of a wide spectrum;

FIG. 12 is a schematic diagram of superimposing a direct current bias;

FIG. 13 is a schematic diagram of an architecture of a communication system according to an embodiment of this application;

FIG. 14a is a first framework diagram of implementing positioning and communication by UE by using LEDs according to an embodiment of this application;

FIG. 14b is a second framework diagram of implementing positioning and communication by UE by using LEDs according to an embodiment of this application;

FIG. 15 is a flowchart of an optical communication method according to an embodiment of this application;

FIG. 16 is a flowchart of an optical communication method according to an embodiment of this application;

FIG. 17A and FIG. 17B is a flowchart of an optical communication method according to an embodiment of this application;

FIG. 18 is a schematic diagram of implementing positioning and communication by UE by using LEDs according to an embodiment of this application;

FIG. 19 is a schematic diagram of implementing positioning and communication by a plurality of UEs by using LEDs according to an embodiment of this application;

FIG. 20 is a schematic diagram of a communication apparatus 200 according to an embodiment of this application; and

FIG. 21 is a schematic diagram of another communication apparatus according to an embodiment of this application.

### DESCRIPTION OF EMBODIMENTS

An electromagnetic spectrum (electromagnetic spectrum) is a family of electromagnetic waves that are arranged continuously based on wavelengths (or frequencies) of the electromagnetic waves. A higher frequency (or referred to as a vibration rate) of an electromagnetic wave indicates larger energy and a shorter wavelength of the electromagnetic wave.

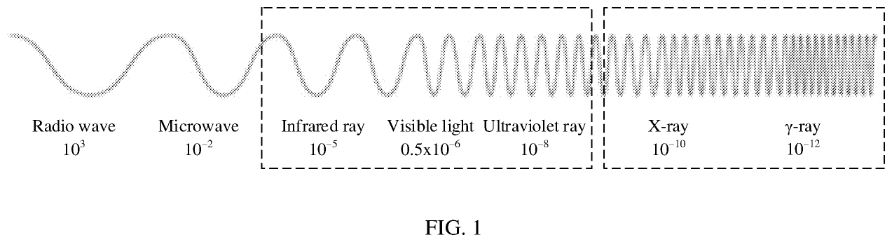

FIG. 1 is a schematic diagram of an electromagnetic spectrum. As shown in FIG. 1, the electromagnetic spectrum may be divided into a radio (radio) wave, a microwave (microwave), an infrared (infrared) ray, visible (visible) light, an ultraviolet (ultraviolet) ray, an X-ray (X-ray) (or referred to as a roentgen ray), and a γ-ray (gamma ray) in descending order of wavelengths of electromagnetic waves. A wavelength of the radio wave ranges from thousands of meters (10³ meters) to about 0.3 meters. A wavelength of the microwave may range from 0.3 meters to 10⁻³ meters. A wavelength of the infrared ray may range from 10⁻³ meters to 7.8×10⁻⁷ meters. A wavelength of the visible light may range from 78×10⁻⁶ centimeters to 3.8×10⁻⁶ centimeters. A wavelength of the ultraviolet ray may range from 3×10⁻⁷ centimeters to 6×10⁻¹⁰ meters. A wavelength of the X-ray may range from 2×10⁻⁹ meters to 6×10⁻¹² meters. A wavelength of the γ-ray may range from 2×10⁻¹⁰ meters to 6×10⁻¹⁴ meters. The radio wave may be used for television and radio broadcasting. The microwave may be used for radar or another communication system. The infrared ray, the visible light and the ultraviolet ray have not been widely used in communication. The X-ray and the γ-ray are harmful to human bodies.

It should be noted that FIG. 1 is merely an example accompanying drawing. In addition to the electromagnetic waves shown in FIG. 1, another electromagnetic wave may be further included. This is not limited.

In the electromagnetic spectrum shown in FIG. 1, an electromagnetic wave commonly used for wireless communication may include the radio wave and the microwave, but spectrum resources of the radio wave and the microwave are limited. With an increase in communication users and communication services, spectrum resources are congested, and communication quality is degraded. To resolve a problem of spectrum resource congestion, wireless communication systems are gradually developing towards millimeter waves, such as electromagnetic waves in terahertz frequency bands and optical frequency bands, and using the millimeter waves for wireless communication is studied. For example, in recent years, in a light fidelity (light fidelity, Li-Fi) technology, the millimeter waves (such as visible light) is used for wireless communication. The following describes the Li-Fi technology.

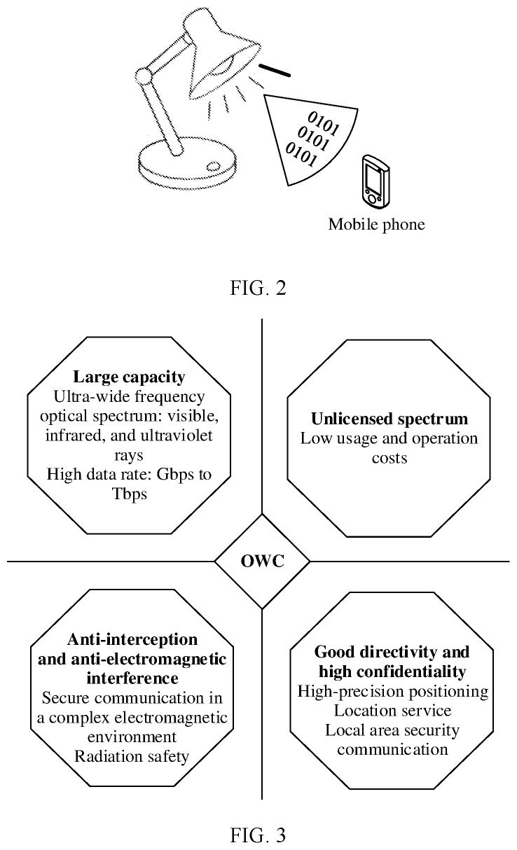

The Li-Fi technology (or referred to as visible light communication (visible light communication, VLC)) is one type of optical wireless communication (optical wireless communication, OWC), and is a white light-emitting diode (light-emitting diode, LED)-based wireless optical communication technology. The Li-Fi technology may implement transmission of a network signal by using flicker light (which may be referred to as visible light). For example, FIG. 2 is a schematic diagram of Li-Fi communication. As shown in FIG. 2, LED light of an LED indicator changes in an intensity, which is invisible to naked eyes. When the light flickers, the LED indicator quickly encodes binary data (for example, 0101 in FIG. 2) sent by a transmitter into a light signal (which may be referred to as a Li-Fi signal or an electrical signal), and effectively transmits the encoded light signal to a receiver (for example, a mobile phone in FIG. 2).

It should be noted that Li-Fi is an example name of visible light communication, and the Li-Fi may also be referred to as VLC or another name. This is not limited. In an embodiment of this application, the VLC is used as an example to describe a visible light communication method.

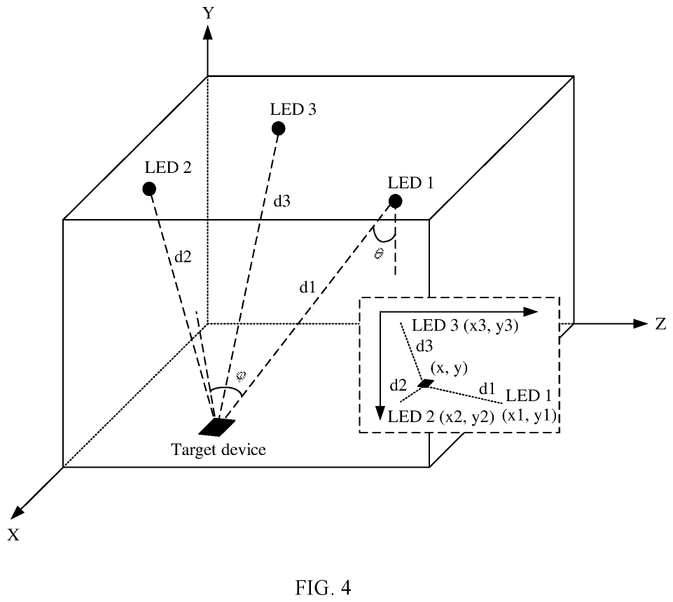

An OWC technology represented by the Li-Fi technology (or referred to as the VLC technology) may have a plurality of advantages shown in FIG. 3: a large capacity, an unlicensed spectrum, anti-interception, good directivity, high confidentiality, and the like. These advantages of the Li-Fi technology (or referred to as the VLC technology) enable wireless optical communication that is based on the Li-Fi technology (or referred to as the VLC technology) to have one or more of the following features: an ultra high frequency optical spectrum (for example, visible, infrared, and ultraviolet), a high data rate (for example, gigabits per second (Gbps) or terabits per second (Tbps)), low usage and operating expenses, secure communication in a complex electromagnetic environment, radiation security, high-precision positioning (or referred to as indoor high-precision positioning), a location service, local area security communication, and the like.

The high-precision positioning (or referred to as the indoor high-precision positioning) is used as an example, and positioning that is based on the VLC technology has an absolute advantage over an existing positioning technology. The existing positioning technology may include: a satellite positioning technology like a global positioning system (global positioning system, GPS), an ultrasonic positioning technology, a wireless fidelity (wireless-fidelity, Wi-Fi) positioning technology, a Bluetooth positioning technology, and the like. The satellite positioning technology like the GPS has become mature in outdoor positioning. However, a radio signal in an indoor environment is blocked by a building, so that a signal received by the GPS is weak. Consequently, positioning precision of the satellite positioning technology like the GPS cannot meet an indoor standard. Therefore, the satellite positioning technology like the GPS is difficult to be applied to the indoor environment. In the ultrasonic positioning technology, distance measurement is performed based on a time difference between an echo and a transmit wave, and positioning precision is high. However, a large quantity of measurement devices need to be deployed in space, and positioning costs are high. In the Bluetooth positioning technology, positioning is performed by measuring a received signal strength, and the Bluetooth positioning technology is suitable for short-distance and small-range positioning. However, the Bluetooth positioning technology is unstable. In the Wi-Fi positioning technology, positioning is performed by measuring a distance between a user and a wireless hotspot, and the Wi-Fi positioning technology is vulnerable to interference of another signal. In addition, power consumption of a locator is high. Compared with the foregoing positioning technologies, a VLC-based indoor positioning technology has the following advantages: (1) A VLC indoor positioning system uses an LED as a light source, and the LED has advantages such as a long service life, low power consumption, a small size, and environmental friendliness. (2) For good lighting effect, LEDs are distributed all over a room, and received signals are strong. The positioning system is stable and positioning precision is high. (3) VLC indoor positioning depends on natural conditions of indoor LEDs, and no additional special transmission point needs to be deployed. This reduces device and maintenance fees, so that costs are low. (4) LED popularization and an advantage of no electromagnetic interference make the VLC indoor positioning applicable to a plurality of harsh scenarios, and widely used.

FIG. 4 is a schematic diagram of a principle of a VLC-based indoor positioning technology. As shown in FIG. 4, a plurality of light sources (for example, an LED 1, an LED 2, and an LED 3 in FIG. 4) may be placed around a target device (which may be a device that needs to be positioned), horizontal distances d (for example, d1, d2, and d3 in FIG. 4) between the light sources and the target device may be obtained through measurement, and current location information (x, y) of the target device may be obtained by positioning with reference to the horizontal distances d between the light sources and the target device and location information of the light sources (LED 1 (x1, y1), LED 2 (x2, y2), and LED 3 (x3, y3) in a two-dimensional plane shown in FIG. 4).

Specifically, the horizontal distances d between the light sources and the target device may be obtained through measurement according to a received signal strength (received signal strength, RSS) positioning principle, ambient light sensor (ambient light sensor, ALS)-based wireless optical RSS positioning, or the like; and in LED-based wireless optical communication, the current location information of the target device may be obtained through calculation with reference to the horizontal distances d between the light sources and the target device and the location information of the light sources. It should be understood that the RSS in an embodiment of this application may be further understood as a received signal strength indication (received signal strength indication, RSSI).

The following describes the RSS positioning principle and the ALS-based wireless optical RSS positioning.

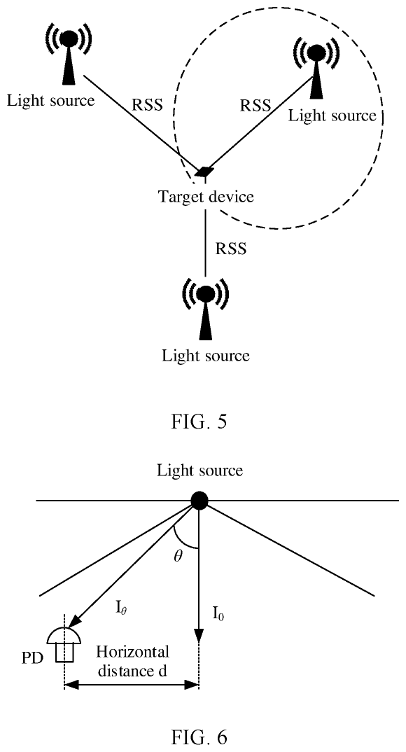

FIG. 5 is a schematic diagram of the RSS positioning principle. As shown in FIG. 5, a plurality of light sources (or referred to as LED light sources or LED indicators) may be placed around a target device (which may be a device that needs to be positioned), each light source transmits a signal (which may be referred to as an optical signal) to the device, the target device obtains horizontal distances d from the target device to the light sources based on a detected strength (which may be referred to as the RSS) of transmitted signals from the light sources, and obtains location information indicating locations of the light sources. Further, based on the horizontal distances d between each light source and the target device and the location information of the light sources, location coordinates of the device are obtained through calculation by using a corresponding positioning algorithm. The positioning algorithm may include a trilateration positioning method, a least square method, and the like.

The least square method is used as an example. Three light sources separately measure and obtain horizontal distances d₁, d₂, and d₃ between the three light sources and the target device. Three circles are drawn by using the light sources as circle centers and the measured distances as radiuses. A location of an intersection point of the three circles is a location of the target device. Optionally, an estimated location of the target device may be calculated according to the least square (least square method, LS) algorithm. For example, it is assumed that location coordinates of the target device are (x, y), location coordinates of an i^{th} light source in N light sources are (xᵢ, yᵢ), a value range of i is [1, N], and Nis an integer greater than or equal to 3. As shown in FIG. 5, N=3, and the location coordinates of the light source, the horizontal distance between the light source and the target device, and the location coordinates of the target device satisfy the following formula (1):

$${( {x}_{i} - x )}^{2} + {( {y}_{i} - y )}^{2} = {d}_{i}^{2} \qquad Formula ( 1 )$$

The formula (1) is expanded, and the following may be obtained through simplification:

$${x}_{i}^{2} + {y}_{i}^{2} + {x}^{2} + {y}^{2} - 2 {x}_{i} x - 2 {y}_{i} y = {d}_{i}^{2}$$

$$⇓ {K}_{i} = {x}_{i}^{2} + {y}_{i}^{2} , R = {x}^{2} + {y}^{2}$$

$$⇓ {r}_{i}^{2} - {K}_{i} = - 2 {x}_{i} x - 2 {y}_{i} y + R$$

$$⇓ [ \begin{matrix}{d}_{1}^{2} - {K}_{1} \\ {d}_{2}^{2} - {K}_{2} \\ ⋮ \\ {d}_{N}^{2} - {K}_{N}\end{matrix} ] = [ \begin{matrix}- 2 {x}_{1} & - 2 {y}_{1} & 1 \\ - 2 {x}_{2} & - 2 {y}_{2} & 1 \\ ⋮ & ⋮ & ⋮ \\ - 2 {x}_{N} & - 2 {y}_{N} & 1\end{matrix} ] [ \begin{matrix}x \\ y \\ R\end{matrix} ]$$

$$⇓ Y = AX$$

The least square method may be used to obtain X=(A^{T}A)⁻¹ A^{T}Y, and then the current location coordinates (x, y) of the target device are obtained.

It can be learned from the foregoing that, when the location information of the target device is calculated, the horizontal distance d between the light source and the target device is an important parameter. In a possible design, in an RSS-based positioning principle, the horizontal distance d between the light source and the target device may be determined based on RSS of a transmitted signal from the light source to the target device. For example, as shown in FIG. 6, it is assumed that the light source transmits the signal to the target device at a transmit angle θ, and distribution of a light emitting intensity of the light source complies with a near-Lambertian light source model. In this case, the light emitting intensity I_{θ} from the transmit angle θ satisfies the following formula (2):

$${I}_{θ} = {I}_{0} {COS}^{m} θ \qquad Formula ( 2 )$$

In the formula (2), I₀ is a light emitting intensity perpendicular to a light emitting surface (that is, a light emitting surface whose transmit angle is θ), m is a radiation modulus (that is, order), m represents a concentration degree of a light source, and an expression of m is shown in the following formula (3):

$$m = \frac{- ln 2}{ln ( cos {θ}_{1 / 2} )} \qquad Formula ( 3 )$$

In the formula (3), θ_{1/2} is a half-power angle or a half-light intensity angle of the light emitting intensity of the light source, and 2θ_{1/2} may be generally referred to as a light beam angle of a light source device, that is, a maximum effective light emitting angle.

In an indoor wireless optical communication channel model, according to a radiation characteristic of a near-Lambertian light source, in a line of sight (line of sight, LOS), a relationship between a received optical power Pr (or referred to as a receive power Pr or a received signal strength Pr) by a photoelectric detector (photoelectric detector, PD) in the target device and a transmit power Pt of a transmitter (for example, the light source in FIG. 5) satisfies the following formula (4):

$$Pr = Pt \cdot \frac{( m + 1 )}{2 π} {cos}^{m} θ cos φ {T}_{S} g \frac{{A}_{r}}{{d}^{2}} \qquad Formula ( 4 )$$

Formula (4) may be changed into

$$\frac{Pr}{Pt} = \frac{( m + 1 )}{2 π} {cos}^{m} θ cos φ {T}_{S} g \frac{{A}_{r}}{{d}^{2}} ,$$

where Pr/Pt is a power attenuation percentage.

In the formula (4), θ and φ respectively represent a transmit angle of the light source and a receive angle of the target device, and if the target device and the transmitter are horizontally placed, φ=θ; T_{S} and [symbol] respectively represent an optical filter gain and a light concentration gain of the target device; and Aᵣ is an effective receiving area of a receiver, and d is a direct distance (or referred to as a horizontal distance) between the target device (for example, a PD or a receiver of the target device) and a transmitter (or a transmitter device) of the light source. It can be learned from the formula obtained after the formula (4) is changed that there is an association relationship between the horizontal distance d between the target device and the light source and the power attenuation percentage, and the horizontal distance d between the target device and the light source may be obtained through calculation based on the power attenuation percentage and another known parameter.

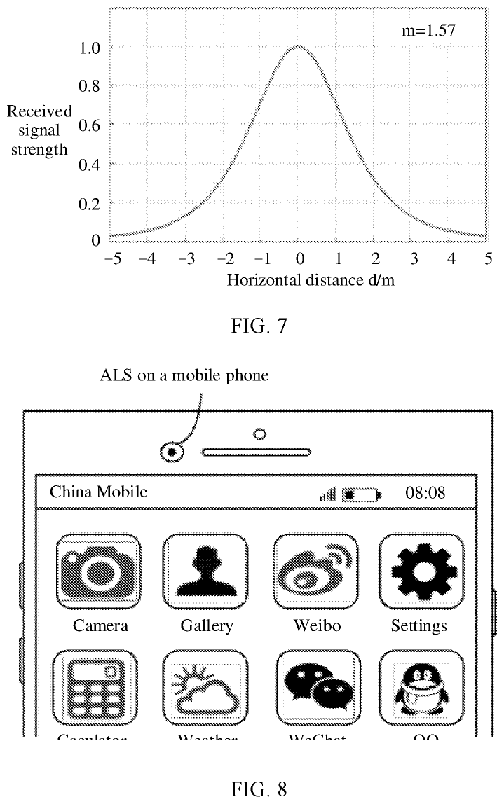

Optionally, as shown in FIG. 7, a one-to-one correspondence between the received signal strength by the target device (or the receiver of the target device) and the horizontal distance d between the target device (or the receiver of the target device) and the light source may be obtained based on a light intensity distribution feature of the LED and according to the foregoing formula (4). It should be noted that a height m of the light source in a correspondence scenario shown in FIG. 7 is known, for example, may be m=1.57.

In still another possible design, in the ALS-based wireless optical RSS positioning, an ALS may be disposed on the target device. For example, as shown in FIG. 8, it is assumed that a target device is a terminal (or referred to as a mobile terminal or a mobile phone), an ALS may be disposed on the terminal, for example, the ALS is disposed on the top of a surface on which a user interaction interface of the terminal is located. The ALS may provide information about an ambient light level to automatically control screen brightness of the mobile target device. A key feature of the ALS is low power consumption. For example, a power of the ALS may be at a milliwatt (mW) level. A plurality of low-power-consumption target devices or applications may continuously obtain data from the ALS without worrying about battery life. In a positioning scenario, a positioning program is installed on a target device having an ALS, and the positioning program may store location information of a light source, a transmit power of the light source, and a corresponding switching frequency. One light source corresponds to one fixed switching frequency (which may be referred to as a fixed frequency), and different light sources correspond to different switching frequencies. In this way, the light source controls switching of the light source by using a fixed frequency corresponding to the light source, so that a flicker frequency of the light source is consistent with the fixed frequency of the light source. In this way, the light source is identified based on a frequency of an optical signal generated by flicker of the light source, and the target device is located based on the location information of the light source and the transmit power of the light source.

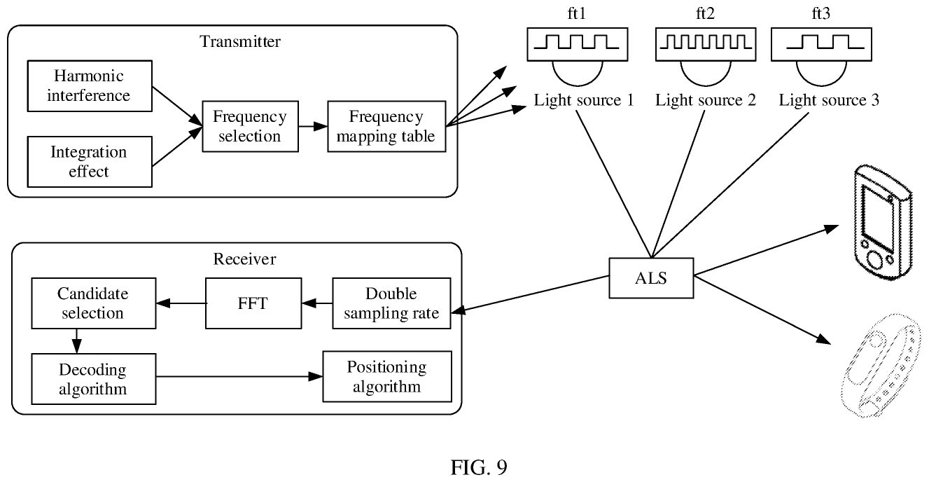

For example, FIG. 9 is an ALS-based wireless optical RSS positioning process. As shown in FIG. 9, a transmitter (transmitter) generates three fixed-frequency square waves through processing such as harmonic interference (harmonic interference), integration effect (integration effect), frequency selection (frequency selection), and a frequency mapping table (frequency mapping table), where the fixed frequencies of the three square waves may be ft1, ft2, and ft3 in FIG. 9, and the three square waves respectively correspond to three light sources (a light source 1, a light source 2, and a light source 3). The three square waves control flicker frequencies (or switching frequencies) of the light sources at the fixed frequencies, to trigger the three light sources to respectively transmit optical signals with the fixed frequencies ft1, ft2, and ft3. After receiving the optical signals sent by the three light sources, a target device (for example, a mobile phone or a smart band in FIG. 9) that uses an ALS performs processes such as double sampling rate (double sampling rate), fast Fourier transform (fast Fourier transformation, FFT), candidate selection (candidate selection), a decoding algorithm (decoding algorithm), and a positioning algorithm (positioning algorithm) to identify the flicker frequencies of the light sources, identify the light sources and receive powers based on the flicker frequencies, and then use the foregoing formula (4) to obtain power attenuation percentages between optical powers (or referred to as receive powers) of received signals transmitted by the light sources and transmit powers based on location information and the transmit powers that are stored and that are of the light sources, and obtain the horizontal distances d between the light sources and the target device based on the power attenuation percentages. Further, current location information of the target device is obtained based on the location information of the light sources, the horizontal distances d between the light sources and the target device, and the multilateral positioning method shown in formula (1).

The foregoing describes a process of implementing device positioning by using visible light. In the positioning process, only positioning can be implemented, and inter-device communication (for example, transmitting a useful information bit stream between devices) based on the visible light cannot be implemented while positioning is implemented. For example, in the RSS-based positioning process shown in FIG. 5, the location information of the target device may be obtained through positioning by learning the transmit powers of the light sources and the receive power of the target device, and another operation is not performed or not required to obtain other information (for example, an information bit stream transmitted between devices). For another example, in an ALS-based positioning principle shown in FIG. 9, a specific light source may be identified by designing a transmit signal of a fixed frequency for the light source, and the location information of the target device is obtained by positioning based on pre-stored location information, a pre-stored transmit power, and the like of the light source. In an ALS-based positioning process, a light source is periodically/regularly switched on/off, and an on/off state of the light source is periodically unchanged. A signal transmitted by the light source does not carry other additional information (for example, information corresponding to an information bit stream), and certainly, the inter-device communication cannot be implemented.

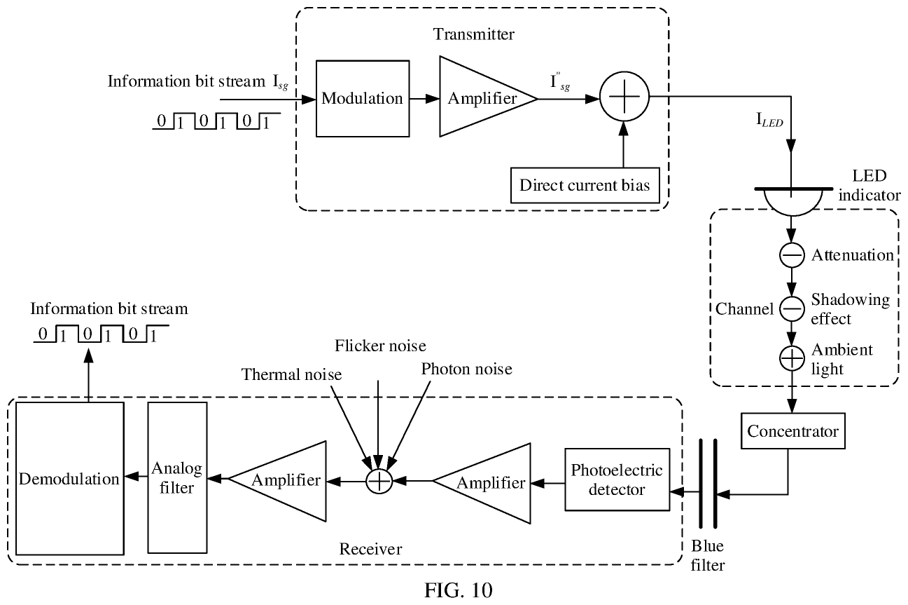

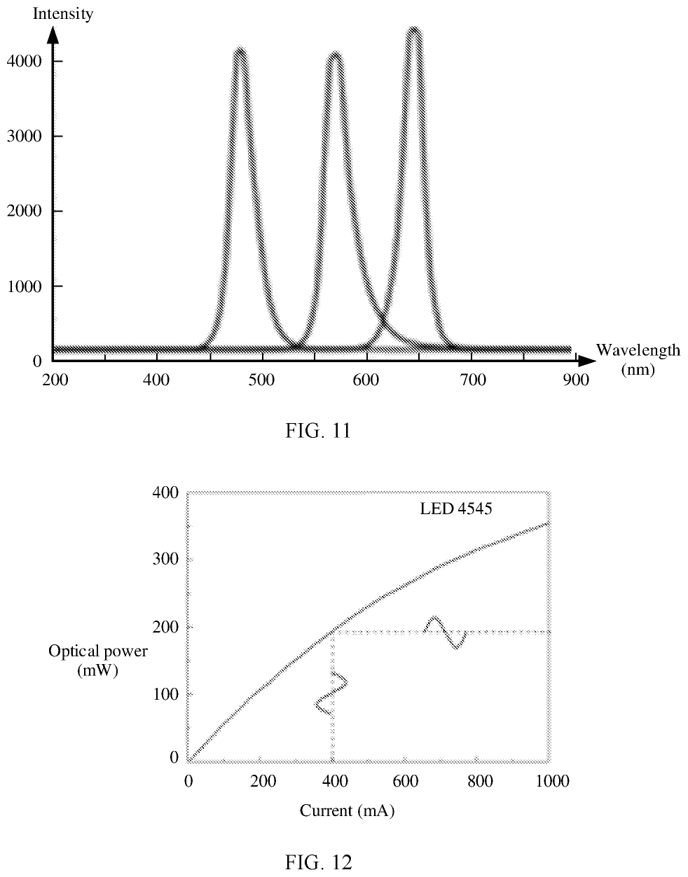

In addition, in an existing process of the inter-device communication (for example, transmitting a useful information bit stream between devices) based on the visible light, only inter-device communication is implemented, and positioning cannot be implemented. In other words, device positioning cannot be implemented while inter-device communication is implemented. For example, the inter-device communication based on the visible light is shown in FIG. 10.

FIG. 10 is a schematic diagram of an architecture of an LED-based wireless optical communication system. As shown in FIG. 10, the LED-based wireless optical communication system may include an optical signal transmitter (which may be referred to as a transmitter (transmitter) for short), an optical signal transmission channel (which may be referred to as a channel (channel) for short), and an optical signal receiver (which may be referred to as a receiver (receiver) for short). The optical signal transmitter includes a modulation (modulation) module, an amplifier (amplifier, AMP), a drive circuit (not shown in the figure), an optical transmitter (not shown in the figure), and the like. An original binary signal (or referred to as an information bit stream) is encoded and modulated by I_{sg} at the transmitter to obtain a signal I′_{sg}, and I′_{sg} may be positive or negative. A direct current bias (DC bias) is superimposed on I′_{sg}, and after analog-to-digital conversion, the optical transmitter (such as an LED indicator) is driven to control a light intensity of the signal, thereby implementing conversion from an electrical signal to an optical signal I_{LED}. The modulated optical signal I_{LED} is transmitted in a channel, for example, transmitted in an atmospheric or underwater channel. The optical signal transmitted through the channel may experience signal attenuation (attenuation), shadowing effect (shadowing effect), and ambient light (ambient light) scrambling. The optical signal transmitted through the channel passes through a concentrator (concentrator) and a blue filter (blue filter) to the optical signal receiver. The optical signal receiver includes a receiving antenna (not shown in the figure), a photoelectric detector (photoelectric detector), an amplifier, an analog filter (analog filter), a demodulation (demodulation) module, and the like. After receiving the optical signal, the photoelectric detector at the receiver may convert the optical signal into an electrical signal. The converted electrical signal is processed by an amplifier and superimposed with signals such as thermal noise (thermal noise), flicker (flicker) noise, and photon noise (photon noise), and then processed by the amplifier, an analog filter, and a demodulator to obtain the original binary signal (or referred to as the information bit stream) I_{sg}.

In an embodiment of this application, the photoelectric detector may include a positive-intrinsic-negative (positive-intrinsic-negative, PIN) photodiode, or an avalanche photodiode (avalanche photodiode, APD).

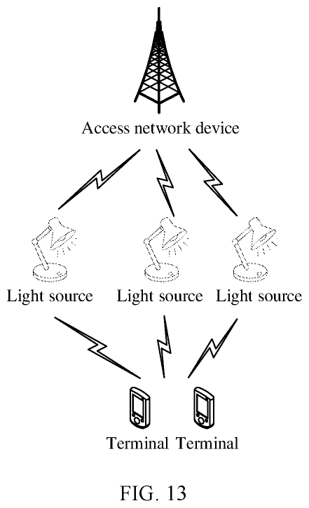

Because the LED indicator emits light spontaneously, a frequency and a phase of an output photon are independent of each other, and an optical spectrum is a wide spectrum shown in FIG. 11, phase modulation of a carrier cannot be performed on a signal output by the LED, and intensity modulation (or referred to as non-coherent modulation) instead of coherent modulation is used when LED-based wireless optical communication shown in FIG. 10 is performed. In addition, during the intensity modulation, because an output intensity of the LED indicator cannot be a negative value, a to-be-transmitted signal needs to be superimposed with the direct current bias, and then the LED is driven. For example, as shown in FIG. 12, a 400 milliamperes (mA) direct current bias may be superimposed on the to-be-transmitted signal, so that the output intensity of the to-be-transmitted signal is always a positive value. For example, an output power of the intensity of the to-be-transmitted signal remains at about 200 milliwatts (mW).

The method shown in FIG. 12 can only implement inter-device communication based on the visible light, but cannot implement device positioning at the same time. The reason is as follows: An optical spectrum of an optical signal emitted by the LED is a wide spectrum, and only intensity modulation can be performed, but coherent modulation cannot be performed. Because the intensity modulation cannot demodulate optical signals emitted by a plurality of (for example, three or more) LED light sources, the method shown in FIG. 12 is not applicable to a scenario in which communication is implemented by using a plurality of LED light sources. However, in the foregoing RSS-based positioning process or ALS-based positioning process, to implement device positioning based on the LED light source, at least three LED light sources are required. Therefore, the method shown in FIG. 12 cannot be combined with the device positioning. In other words, in the conventional technology, the inter-device communication and inter-device positioning cannot be integrated together. However, in an actual communication scenario (for example, cell handover or access), reliable inter-device communication needs to be implemented based on positioning data obtained in real time.

To integrate inter-device communication and device positioning that are based on the visible light, and integrate the two, an embodiment of this application provides an optical communication method. The method may include: A first communication device receives optical signals separately transmitted by N nodes; and obtains, based on the received optical signals of the N nodes, first parameters that are of the N nodes and that are used to locate the first communication device and an information bit stream corresponding to each node. The optical signals are obtained by the nodes by performing electrical-to-optical conversion on first signals, the first signal is a signal obtained by adding a direct current bias signal to a second signal, the second signal is a signal obtained after constant envelope modulation is performed on an information bit stream to be sent by a light source node to the first communication device, and different nodes correspond to different frequencies of carriers used for constant envelope modulation, to distinguish different nodes. In this way, in a visible light-based positioning scenario in which at least three nodes exist, constant envelope modulation is performed on an information bit stream to be sent by each node. Constant envelope modulation of different nodes is performed on different carriers, that is, spectrums of modulated signals are different, and different nodes correspond to different spectrums, so that a receiver/target device (for example, the first communication device in embodiments of this application) can perform coherent demodulation on received signals sent by a plurality of nodes, and identify, based on spectrums of the demodulated signals (or referred to as signal spectrums), the node that transmits the signal, obtain an information bit stream transmitted by the node, obtain a power attenuation percentage corresponding to the node, and obtain a horizontal distance between the node and the device based on the power attenuation percentage. In this way, device positioning is implemented based on location information of the plurality of nodes and horizontal distances between the plurality of nodes and the device.

The following describes the optical wireless communication method provided in embodiments of this application with reference to the accompanying drawings.

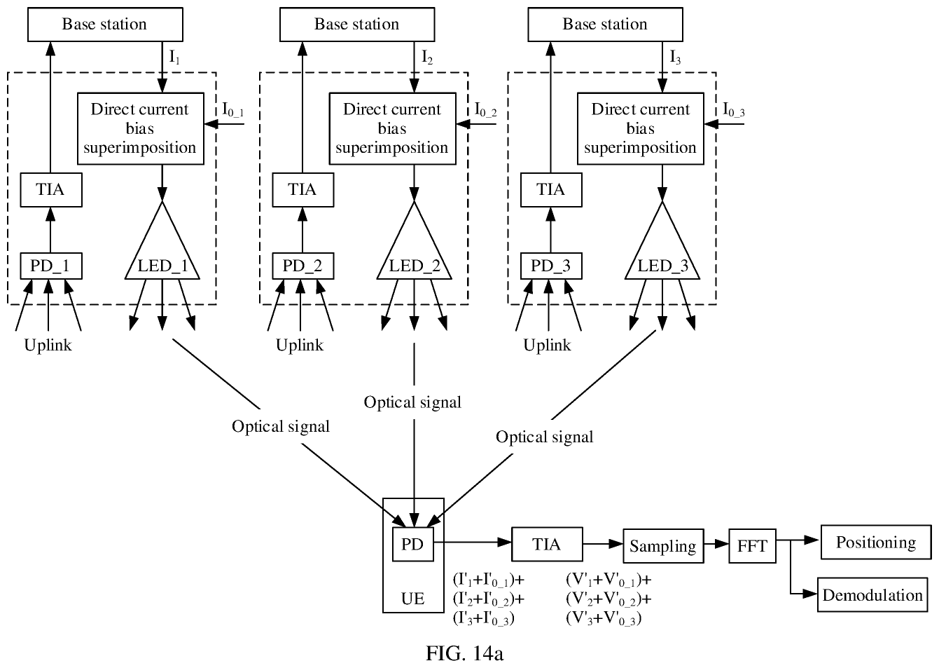

The optical wireless communication method provided in embodiments of this application may be applied to any one of a 4th generation (4th generation, 4G) system, a long term evolution (long term evolution, LTE) system, a 5th generation (5th generation, 5G) system, a new radio (new radio, NR) system, an NR-vehicle-to-everything (vehicle-to-everything, V2X) system, an Internet of Things system, or another next-generation communication system. This is not limited. The following uses a communication system shown in FIG. 13 as an example to describe the optical wireless communication method provided in embodiments of this application.

FIG. 13 is a schematic diagram of a communication system according to an embodiment of this application. As shown in FIG. 13, the communication system may include an access network device, a plurality of light sources (which may be referred to as nodes, visible light nodes, or the like in embodiments of this application), and a plurality of terminals. It should be noted that FIG. 13 is an example framework diagram. A quantity of nodes included in FIG. 13 is not limited, and in addition to function nodes shown in FIG. 13, other nodes such as a core network device, a gateway device, and an application server may be further included.

The access network device is mainly configured to implement functions such as resource scheduling, radio resource management, and radio access control of the terminal. Specifically, the access network device may be any node of a base station, a small base station, a wireless access point, a transmission receive point (transmission receive point, TRP), a transmission point (transmission point, TP), and another access node.

The light source may be a node that can provide an LED, and may be an LED indicator or another LED device. The light source may be configured to: convert an electrical signal sent by the access network device to the terminal into an optical signal, and transmit the optical signal; and/or receive an optical signal sent by the terminal to the access network device, and report the optical signal to the access network device.

The terminal may be terminal equipment (terminal equipment), user equipment (user equipment, UE), a mobile station (mobile station, MS), a mobile terminal (mobile terminal, MT), or the like. Specifically, the terminal may be a mobile phone (mobile phone), a tablet computer, or a computer with a wireless transceiver function, or may be a virtual reality (virtual reality, VR) terminal, an augmented reality (augmented reality, AR) terminal, a wireless terminal in industrial control, a wireless terminal in self-driving, a wireless terminal in telemedicine, a wireless terminal in a smart grid, a wireless terminal in a smart city (smart city), a smart home, an in-vehicle terminal, or the like. In embodiments of this application, an apparatus configured to implement a function of the terminal may be a terminal, or may be an apparatus that can support the terminal to implement the function, for example, a chip system (for example, a chip or a processing system including a plurality of chips). The following describes the optical wireless communication method provided in embodiments of this application by using an example in which the apparatus for implementing the function of the terminal is a terminal.

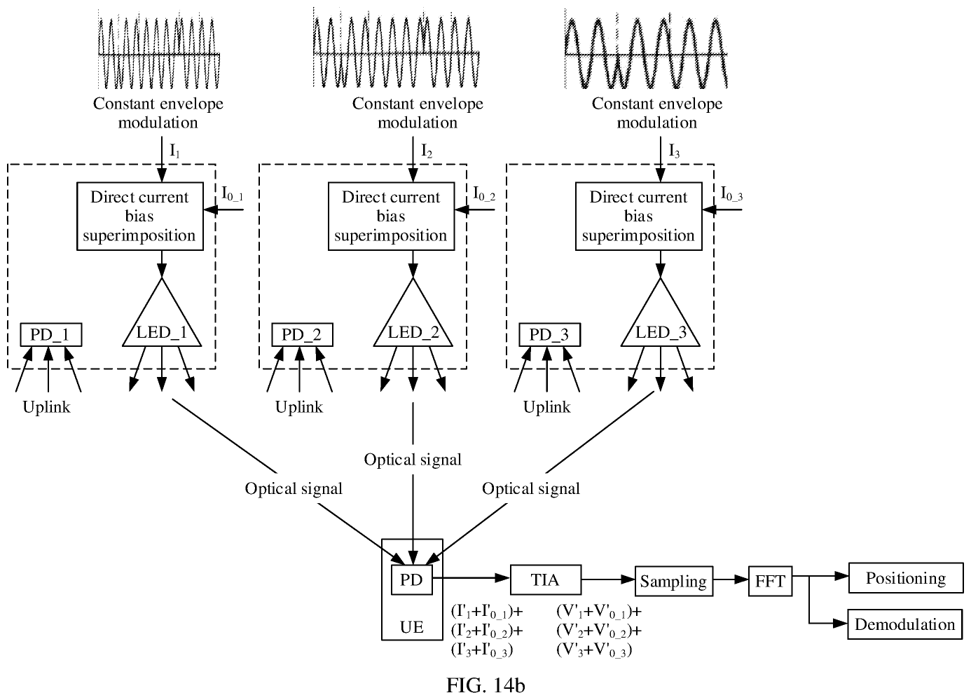

For example, the light sources shown in FIG. 13 includes an LED_1, an LED_2, and an LED_3, the access network device is a base station, and the terminal is UE. A principle block diagram of the method according to this embodiment of this application is shown in FIG. 14a or FIG. 14b. All LEDs use constant envelope modulation for to-be-sent information bit streams, and signals transmitted by a single LED have a same spectral shape. After a direct current bias signal is superimposed on a signal obtained after constant envelope modulation, the LED is driven to transmit a signal. Different LEDs use different transmit frequencies, to ensure that spectrums of transmitted signals do not overlap. A PD of the UE receives optical signals sent by each LED and performs optical-to-electrical conversion to obtain signals (I′₁+I′_{0_1})+(I′₂+I′_{0_2})+(I′₃+I′_{0_3}), obtains voltage signals (V′₁+V′_{0_1})+(V′₂+V′_{0_2})+(V′₃+V′_{0_3}) through processing by a TIA, and obtains signal spectrums after sampling and FFT processing are performed on the voltage signals. The signal spectrums are compared with a spectrum of a carrier used for constant envelope modulation, to determine the LEDs that transmit the signals, to locate the UE based on location information of the LEDs and attenuation power percentages, and demodulate the signals to obtain information bit streams.

Optionally, as shown in FIG. 14a, a PD and a trans-impedance amplifier (trans-impedance amplifier, TIA) may be disposed in each LED, to convert a received uplink optical signal into an electrical signal by using the PD, and convert the electrical signal into a voltage signal by using the TIA, and send the voltage signal to the base station. Optionally, as shown in FIG. 14b, the LED may not include a TIA.

The following describes the optical communication method provided in embodiments of this application with reference to the communication system shown in FIG. 13. For actions, terms, and the like involved in the following embodiments, reference may be made to each other. Names of messages exchanged between devices, names of parameters in the messages, and the like in embodiments are merely examples, and other names may also be used in specific implementation. This is not limited. In addition, terms “first”, “second”, and the like in embodiments of this application are used to distinguish between different objects, but are not used to describe a specific order of the objects. Attributes of different objects represented by “first” and “second” are not limited in embodiments of this application.

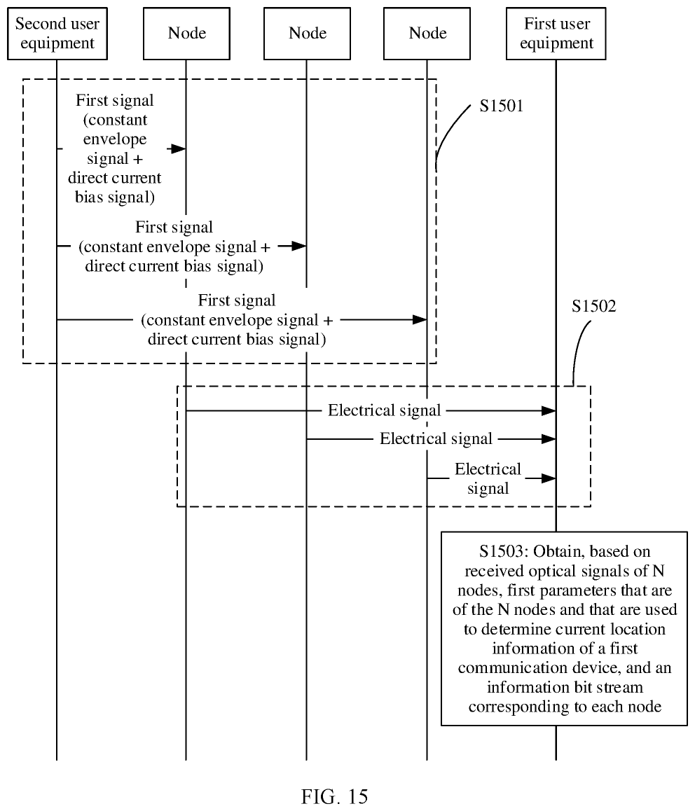

FIG. 15 is a flowchart of an optical communication method according to an embodiment of this application. As shown in FIG. 15, the method may include the following steps.

S1501: A second communication device transmits first signals to N nodes. Correspondingly, the N nodes receive the first signals.

The second communication device may be the access network device in FIG. 13, for example, may be a base station. In an embodiment of this application, the second communication device may be referred to as a transmitter, or may be a device that transmits an information bit stream.

N is an integer greater than or equal to 3. The nodes may be the light sources or the LED indicators shown in FIG. 13.

First signals received by different nodes are different. The first signal may be a signal obtained after the second communication device processes an information bit stream (for example, the signal I_{sg} in FIG. 10) to be sent to a first communication device by using a node. For example, the first signal may be a signal obtained by amplifying a second signal and adding a direct current bias signal, where the second signal is obtained by performing constant envelope modulation on the information bit stream and is a constant envelope signal. The information bit stream may be a binary bit stream corresponding to useful information to be sent by the second communication device to the first communication device. Information bit streams corresponding to different nodes may be different or the same.

The constant envelope modulation may indicate that a signal is modulated by using a carrier, so that an envelope of a modulated signal is constant, and a center frequency of a spectrum of the modulated signal is the same as a center frequency of the carrier. The constant envelope modulation may include minimum shift keying (minimum shift keying, MSK) modulation, Gaussian minimum shift keying (Gaussian minimum shift keying, GMSK), binary phase shift keying (binary phase shift keying, BPSK), or the like. Specifically, for a constant envelope modulation scheme, refer to the conventional technology. It should be understood that different nodes correspond to different carriers with different center frequencies used for the constant envelope modulation, so that the first communication device identifies, by comparing a center frequency of a received signal with a center frequency of a carrier used for the constant envelope modulation, a node that transmits the signal. In an embodiment of this application, the carrier used for the constant envelope modulation may be preconfigured or indicated to the first communication device.

For example, FIG. 14a is used as an example. There are three LEDs: the LED_1, the LED_2, and the LED_3. Carriers F1, F2, and F3 on which constant envelope modulation is performed are pre-configured for each LED. Signals I₁, I₂, and I₃ may be obtained by performing constant envelope modulation on three information bit streams by using the three carriers. I₁, I₂, and I₃ are constant envelope signals whose frequencies (or spectrums) are respectively corresponding to that of F1, F2, and F3. A spectrum of the signal I₁ is the same as that of the carrier F1, a spectrum of the signal I₂ is the same as that of the carrier F2, and a spectrum of the signal I₃ is the same as that of the carrier F3. Other processing is performed on I₁, I₂, and I₃, for example, amplification shown in FIG. 10 and processing such as superimposition of direct current bias signals (such as I_{0_1}, I_{0_2}, and I_{0_3}) are performed to obtain three first signals: (I₁+I_{0_1}), (I₂+I_{0_2}), and (I₃+I_{0_3}). The three first signals are transmitted to the LED_1, the LED_2, and the LED_3 respectively, for example, (I₁+I_{0_1}) is transmitted to the LED_1, (I₂+I_{0_2}) is transmitted to the LED_2 and (13+I_{0_3}) is transmitted to the LED_3.

It should be understood that, in an embodiment of this application, a purpose of superimposing the direct current bias signal is to ensure that an intensity of an output signal is not a negative value, to drive the LED. On the premise that this purpose is achieved, a magnitude of the direct current bias signal may be set based on a requirement, and may be 400 mA or another value. This is not limited.

It should be understood that the signal I in this application may be a current signal or referred to as an electrical signal. For example, I₁, I₂, I₃, I_{0_1}, I_{0_2}, and I_{0_3} are all current signals/electrical signals. The signal V described in this application may be a voltage signal, for example, V′₁, V′₂, V′₃, V′_{0_1}, V′_{0_2}, and V′_{0_3} in the following are all voltage signals.

S1502: Each of the N nodes performs optical-to-electrical conversion on the received first signal to obtain an optical signal, and transmits the optical signal to the first communication device. Correspondingly, the first communication device receives the optical signal.

The first communication device may be any terminal shown in FIG. 13.

Specifically, for a process in which the node performs optical-to-electrical conversion, refer to the conventional technology. Details are not described again. Each node may transmit the optical signal to the first communication device at a specific transmit power. A spectral shape of the optical signal sent by the node is the same as a spectral shape of the carrier used for the constant envelope modulation.

For example, in the example shown in FIG. 14a, the LED_1 transmits (I₁+I_{0_1}) to the UE at a transmit power P_{0_1}, the LED_2 transmits (I₂+I_{0_2}) to the UE at a transmit power P_{0_2}, and the LED_3 transmits (I₃+I_{0_3}) to the UE at a transmit power P_{0_3}. It should be understood that, in this application, the transmit power of the LED may also be referred to as an average transmit power or another name. This is not limited. The transmit power of each LED may be known to the first communication device.

For example, the node may send, on a transmit frequency corresponding to the node, the optical signal to the first communication device through a channel (for example, atmospheric or underwater) between the node and the first communication device.

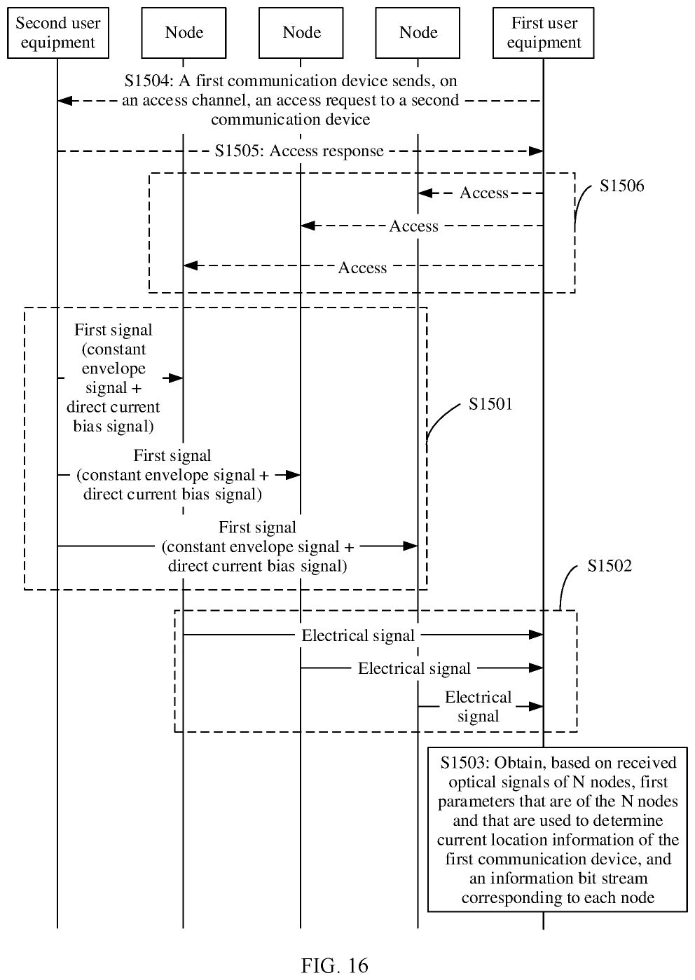

Correspondingly, the first communication device receives the optical signal on the receive frequency corresponding to the node. It should be understood that the channel described in this application may be referred to as a transmission channel, and the channel may be used to transmit a signal between two devices. In addition, the transmit frequency and the receive frequency described in this application are relative concepts. The transmit frequency may be a frequency used by a transmitter to transmit a signal, the receive frequency may be a frequency used by a receiver to receive a signal, and the receive frequency may be the same as the transmit frequency. The transmit frequency and the receive frequency of the node may be collectively referred to as a communication frequency of the node, and the communication frequency may be transmitted by the second communication device to the first communication device in an access process shown in FIG. 16. Transmit frequencies of different nodes are different, so that spectrums of signals transmitted by different nodes do not overlap, and interference between different nodes is avoided.

It should be understood that, in embodiments of this application, spectral shapes, location information, and communication frequencies of signals transmitted by different nodes are known to the first communication device. For example, the node and the carrier used for the constant envelope modulation, the location information of the node, and the communication frequency are indicated/configured for the first communication device in advance. Optionally, the foregoing information may be configured for the first communication device before S1501 in this application is performed, or may be configured for the first communication device before S1503 is performed. This is not limited.

S1503: The first communication device obtains, based on the received optical signals of the N nodes, first parameters that are of the N nodes and that are used to determine current location information of the first communication device, and an information bit stream sent by the second communication device corresponding to each node to the first communication device by using the node.

It should be understood that, in embodiments of this application, an optical signal received by the first communication device may be different from an optical signal sent by a node to the first communication device, the optical signal received by the first communication device may be an optical signal obtained after the optical signal sent by the node is transmitted through a channel, and the optical signal received by the first communication device is equal to the optical signal that is sent by the node and that is multiplied by a channel matrix H(f). It should be understood that the channel described in this application may be a transmission channel between the node and the first communication device.

The first parameter may include a horizontal distance d between the node and the first communication device and location information of the node, and the first parameters of the N nodes may be used to determine the current location information of the first communication device. For example, the current location information of the first communication device may be determined by using the first parameters of the N nodes and with reference to the multilateral positioning method shown in formula (1).

For example, that the first communication device obtains, based on the received optical signals of the N nodes, first parameters that are of the N nodes and that are used to determine current location information of the first communication device, and an information bit stream sent by the second communication device corresponding to each node to the first communication device by using the node may include:

The first communication device performs optical-to-electrical conversion processing on the received N optical signals to obtain N third signals, where the third signals may refer to signals (or may be understood as attenuated first signals) obtained by transmitting the first signals the first communication device through the channel, and the third signals include attenuated second signals (or may be understood as signals obtained by transmitting the second signals to the first communication device through the channel) and attenuated direct current bias signals (or may be understood as signals obtained by transmitting the direct current bias signals to the first communication device through the channel). For example, the N nodes separately transmit the optical signals. Correspondingly, the first communication device receives the N optical signals, and optical-to-electrical conversion is performed on the N optical signals to obtain the N third signals.

For each third signal, the first communication device processes the third signal to obtain a spectrum of the third signal; compares a center frequency of the spectrum of the third signal with a center frequency of a carrier used by each node to perform constant envelope modulation; if a center frequency of a carrier used by the first node is the same as a spectrum of the center frequency of the spectrum of the third signal, determines that an optical signal corresponding to the third signal is an optical signal transmitted by the first node, obtains a power attenuation percentage based on a receive power when the optical signal corresponding to the third signal is received and a transmit power when the first node transmits the optical signal, and determines a horizontal distance d between the first communication device and the first node based on the power attenuation percentage. The first communication device obtains the location information of the first node according to a stored correspondence between a node and location information of the node. In addition, the first communication device performs processing such as demodulation on the third signal to obtain the information bit stream. After each third signal is traversed, the first parameter of each of the N nodes and the information bit stream corresponding to each node may be finally obtained.

The first communication device may learn, in advance, a carrier that is corresponding to the node and that is used for constant envelope modulation. After receiving a signal, the first communication device may compare whether a center frequency of a spectrum of the received signal is the same as a center frequency of the carrier, find a carrier whose center frequency is the same as the center frequency of the received signal, and determine that the received signal is a signal transmitted by the node corresponding to the carrier. For example, FIG. 14b is used as an example. The LED_1 corresponds to the carrier F1, and the carrier F1 is used to perform constant envelope modulation on the information bit stream to obtain I₁. The LED_2 corresponds to the carrier F2, and the carrier F2 is used to perform constant envelope modulation on the information bit stream to obtain I₂. The LED_3 corresponds to the carrier F3, and the carrier F3 is used to perform constant envelope modulation to obtain I₃. It can be learned from FIG. 14b that frequencies of carriers corresponding to different LEDs are different. The UE may separately process the received signals to obtain spectrums (I′₁+I′_{0_1}), (I′₂+I′_{0_2}), and (I′₃+I′_{0_3}). If it is found that center frequencies of the spectrums (I′₁+I′_{0_1}), (I′₂+I′_{0_2}), and (I′₃+I′_{0_3}) respectively correspond to a center frequency of F1, a center frequency of F2, and a center frequency of F3, it is determined, according to a known correspondence between a carrier and an LED, that the received signals are respectively signals sent by the LED_1, the LED_2, and the LED_3.

The power attenuation percentage may be equal to a percentage of the receive power when the first communication device receives the optical signal to the transmit power when the first node sends the optical signal. For a manner of determining the horizontal distance d between the first communication device and the first node based on the power attenuation percentage, refer to the foregoing formula (4). Details are not described again.

The receive power when the first communication device receives the optical signal may be determined based on a current value of an electrical signal corresponding to the received optical signal. For the first communication device, the current value is in a linear relationship with the receive power. For example, FIG. 14a is used as an example. The LED_1 performs optical-to-electrical conversion on the received signal (I₁+I_{0_1}) and transmits the signal to the UE through the channel. The PD of the UE converts the received optical signal into the electrical signal (I′₁+I′_{0_1}), and a receive power P′_{0_1}=f(I′₁, I′_{0_1}). The transmit power (or referred to as an average power) when the first node transmits light may be an optical power. The optical power is linearly related to a current, and the average power depends on an average current. For example, FIG. 14a is used as an example. The LED_1 performs optical-to-electrical conversion on the signal (I₁+I_{0_1}) transmitted by a base station to obtain an optical signal, and then transmits the optical signal to the UE through the channel. In this case, an optical power of the LED_1 is P_{0_1}=f(I₁, I_{0_1}). Further, in the example shown in FIG. 14a, for the LED_1, a power attenuation percentage of the LED_1 is P′0_1/P_{0_1}. It should be understood that, in embodiments of this application, an optical power when each node transmits the optical signal is known to the first communication device.

Because the first signal is a signal obtained after constant envelope modulation is performed on the information bit stream and the direct current bias signal is superimposed, the first signal includes a direct current signal and an alternating current signal, and power attenuation percentages of the direct current signal and the alternating current signal are the same. In other words, a direct current component and an alternating current component in the first signal change proportionally, so that the power attenuation percentage may also be equal to a power attenuation percentage of the direct current component or a power attenuation percentage of the alternating current component. For example, FIG. 14a is used as an example. For the LED_1, the power attenuation percentage=P′_{0_1}/P_{0_1}=I′_{0_1}/I_{0_1}=I′₁/I₁.

It should be understood that the direct current bias signal in embodiments of this application is preconfigured, and direct current bias signals corresponding to different nodes may be the same or different. This is not limited. The first communication device may learn in advance that which node corresponds to which direct current bias signal. In addition, a correspondence between location information of each node and the node may be pre-stored in the first communication device. The location information described in this application may be two-dimensional plane coordinates or the like.

The foregoing uses the first node as an example to describe a process of obtaining the first parameter of the first node and the information bit stream corresponding to the first node. Similarly, for a process of obtaining a first parameter of another node (for example, a second node, a third node, or a fourth node) and an information bit stream corresponding to the another node, refer to the foregoing process. Details are not described again.

For example, that the first communication device performs optical-to-electrical conversion processing on the received optical signals to obtain third signals (or understood as attenuated first signals) may include: After the first communication device uses a photoelectric detector deployed in the first communication device to convert the received optical signals into voltage signals by using a trans-impedance amplifier (trans-impedance amplifier, TIA), the first communication device performs processing such as sampling and FFT on the voltage signals to obtain spectrums of the attenuated first signals, separates the second signals from the attenuated first signals, and demodulates the second signals to obtain the information bit streams. In addition, center frequencies of the spectrums of the attenuated first signals are compared with center frequencies of carriers corresponding to the nodes to obtain nodes whose corresponding carriers have same center frequencies as that of the attenuated first signals, to identify nodes that transmit the signals, and obtain, based on location information of the nodes, power attenuation percentages, and the like, first parameters for positioning.

For example, FIG. 14a is used as an example. The LED_1 performs optical-to-electrical conversion on the received signal (I₁+I_{0_1}) and transmits the signal to the UE through the channel. The UE receives the signal (I′₁+I′_{0_1}), and a corresponding receive power is P′_{0_1}, where I′_{0_1} is a signal (or referred to as an attenuated direct current bias signal) obtained after the direct current bias signal I_{0_1} is transmitted through the channel, and I′₁ is a signal (which may be referred to as an attenuated information bit stream) obtained after the information bit stream I₁ is transmitted through the channel. The LED_2 performs optical-to-electrical conversion on the received signal (I₂+I_{0_2}) and transmits the signal to the UE through the channel. The UE receives the signal (I′₂+I′_{0_2}), and a corresponding receive power is P′_{0_2}, where I′_{0_2} is a signal (or referred to as an attenuated direct current bias signal) obtained after the direct current bias signal I_{0_2} is transmitted through the channel, and I′₂ is a signal (which may be referred to as an attenuated information bit stream) obtained after the information bit stream I₂ is transmitted through the channel. The LED_3 performs optical-to-electrical conversion on the received signal (I′₃+I′_{0_3}) and transmits the signal to the UE through the channel. The UE receives the signal (I′₃+I′_{0_3}), and a corresponding receive power is P_{0_3}, where I′_{0_3} is a signal (or referred to as an attenuated direct current bias signal) obtained after the direct current bias signal I_{0_3} is transmitted through the channel, and I′₃ is a signal (which may be referred to as an attenuated information bit stream) obtained after the information bit stream 13 is transmitted through the channel. The UE performs processing such as TIA, sampling, and FFT on the signal (I′₁+I′_{0_1}) to obtain I′₁ and I′_{0_1}, performs processing such as TIA, sampling, and FFT on the signal (I′₂+I′_{0_2}) to obtain I′₂ and I′_{0_2}, and performs processing such as TIA, sampling, and FFT on the signal (I′₃+I′_{0_3}) to obtain I′₃ and I′_{0_3}. Further, the UE determines that the center frequency of the spectrum of I′₁ is the same as the center frequency of the carrier F1, and determines, according to a correspondence between a carrier and a node, that I′₁ corresponds to the LED_1, that is, I′₁ and I′_{0_1} correspond to the LED_1. The UE determines, according to formula (4), a power attenuation percentage between the transmit power P_{0_1} of the signal transmitted by the LED_1 and the receive power P′0_1 of the signal transmitted by the LED_1 and received by the UE, and then determines a horizontal distance d1 between the LED 1 and the UE based on the power attenuation percentage. Similarly, with reference to a same manner, a horizontal distance d2 between the LED_2 and the UE is determined, a horizontal distance d3 between the LED_3 and the UE is determined, and location information of the UE is obtained through calculation based on the horizontal distance d1, the horizontal distance d2, the horizontal distance d3, and location information that is of each LED and that is stored in the UE by using the algorithm shown in formula (1), to implement positioning of the UE. In addition, I′₁ is demodulated to obtain the information bit stream I₁, I′₂ is demodulated to obtain the information bit stream I₂, and I′₃ is demodulated to obtain the information bit stream I₃. In this way, positioning is implemented, and information bit streams are transmitted at the same time.

Based on the method shown in FIG. 15, all nodes use constant envelope modulation, and signals transmitted by a single node have a same spectral shape. The first communication device receives optical signals transmitted by a group of (at least three) nodes (such as LEDs), converts the optical signals into electrical signals through optical-to-electrical conversion, processes the electrical signals to obtain spectrums of the signals, compares center frequencies of the spectrums of the signals with center frequencies of locally stored carriers, determines the nodes that transmit the signals, obtains location information of the nodes (the location information of the nodes is known to first user equipment), calculates power attenuation percentages of the signals, obtains horizontal distances between the first communication device and each node based on the power attenuation percentages, then calculates location information of the first communication device based on a positioning method, and obtains, through filtering, information bit streams transmitted on corresponding communication frequencies by the first communication device and the nodes.

Optionally, before the second communication device shown in FIG. 15 communicates with the first user equipment by using the N nodes, the first user equipment needs to perform an access process (or referred to as an initial access process) to access the N nodes, to implement mutual signal transmission with the second communication device by using the N nodes. In embodiments of this application, the first communication device may simultaneously access one or more nodes. For example, in a positioning implementation scenario, the first communication device may simultaneously access at least three nodes. This is not limited. As shown in FIG. 16, a process in which the first user equipment accesses the N nodes may include steps S1504 to S1506.

S1504: The first communication device sends, on an access channel, an access request to the second communication device. Correspondingly, the second communication device receives the access request.

The access channel may be a common signal, for example, may be a control signal. One access channel may be shared by one or more first communication devices. In other words, the one or more first communication devices may initiate the access request on the access channel. A frequency of the access channel is different from communication frequencies of all nodes. The access channel may be preconfigured for the first communication device and the second communication device, so that the first communication device sends the access request on the access channel, and the second communication device receives the access request on the access channel.

The access request may include current location information of the first communication device and an identifier of the first communication device. The access request may be used to request to access the node or used to request to communicate with the first communication device by using the node.

In embodiments of this application, the identifier of the first communication device may indicate the first communication device. The identifier of the first communication device may be an Internet protocol (Internet protocol, IP) address of the first communication device, a media access control (media access control, MAC) address of the first communication device, an international mobile subscriber identity (international mobile subscriber identity, IMSI) of the first communication device, a subscriber permanent identifier (subscriber permanent identifier, SUPI) of the first communication device, or a 5G global user temporary identifier (5G global user temporary identifier, 5G-GUTI).

It should be understood that the current location information of the first communication device carried in the access request may be location information of the first communication device when the first communication device initiates access. For example, the first communication device may determine the current location information of the first communication device with reference to the foregoing RSS-based positioning principle or ALS-based positioning principle, and send the current location information to the second communication device by carrying the current location information in the access request.

For example, the ALS-based positioning principle shown in FIG. 9 is used as an example. The first communication device receives, on the access channel, fixed bit streams (which may be a fixed-frequency square wave 101010 . . . shown in FIG. 9) from M nodes, and determines the current location information of the first communication device based on the fixed bit streams of the M nodes, where M is an integer greater than or equal to 3, for example, M=3. Specifically, for a process in which the first communication device determines the current location information of the first communication device based on the fixed bit streams sent by the M nodes, refer to the foregoing description of the process shown in FIG. 9. Details are not described again.

S1505: The second communication device determines, based on the access request, a node that can be accessed by the first communication device, and sends an access response to the first communication device. Correspondingly, the first communication device receives the access response.

The second communication device may send, on the access channel, the access response to the first communication device, and the first communication device receives, on the access channel, the access response from the second communication device.

The access response may include the identifier of the first communication device and communication frequencies of the N nodes, and the access response may be referred to as a downlink acknowledgment (acknowledgment, ACK) message. The communication frequency includes a transmit frequency and a receive frequency.

For example, the second communication device may detect nodes around the first communication device, select, from the nodes around the first communication device, N nodes that are close to the first communication device and whose channels are idle, and use the selected N nodes as nodes that can be accessed by the first communication device.

Optionally, after receiving the access request, the second communication device may reply, to the first communication device, that the access request is successfully received. Correspondingly, the first communication device receives the reply from the second communication device, and waits for the access response on the access channel. If the first communication device does not receive a reply from the second communication device within first preset time after sending the access request, it indicates that the access request may fail to be sent. In this case, the first communication device resends, on the access channel, the access request to the second communication device. The first preset time may be set based on a requirement. This is not limited.

Optionally, after receiving the access response, the first communication device may reply, to the second communication device, that the access response is received. Optionally, if the second communication device does not receive a reply from the first communication device within second preset time after sending the access response, it indicates that the access response may fail to be sent. In this case, the second communication device resends, on the access channel, the access response to the first communication device. The preset time may be set based on a requirement. This is not limited.

Further, after receiving the access response, the first communication device may detect whether the identifier carried in the access response is the identifier of the first communication device. If yes, it indicates that the access response is sent to the first communication device. Further, the first communication device stores a communication frequency of a node carried in the access response, to receive, on the receive frequency corresponding to the transmit frequency and based on the stored communication frequency of the node, a signal from the node. On the contrary, if it is detected that the identifier carried in the access response is not the identifier of the first communication device, the received access response is discarded.

S1506: The first communication device accesses the N nodes in response to the access response.

That the first communication device accesses the N nodes may be understood as that the first communication device establishes a communication connection to each node, for example, switches the communication frequency to a receive frequency corresponding to the node. Subsequently, the first communication device may receive signals from the N nodes through a communication connection and with reference to the method shown in FIG. 15, to implement positioning and information bit stream transmission.

Based on the method shown in FIG. 16, the first communication device may implement positioning based on a fact that the nodes independently transmit fixed bit streams (for example, 101010 . . . ) on respective transmit frequencies of the nodes, and report positioned location information to the second communication device, so that the second communication device, based on the location of the first communication device, indicates, to the first communication device, nodes that are close to the first communication device and whose channels are idle, to indicate the first communication device to access these nodes.

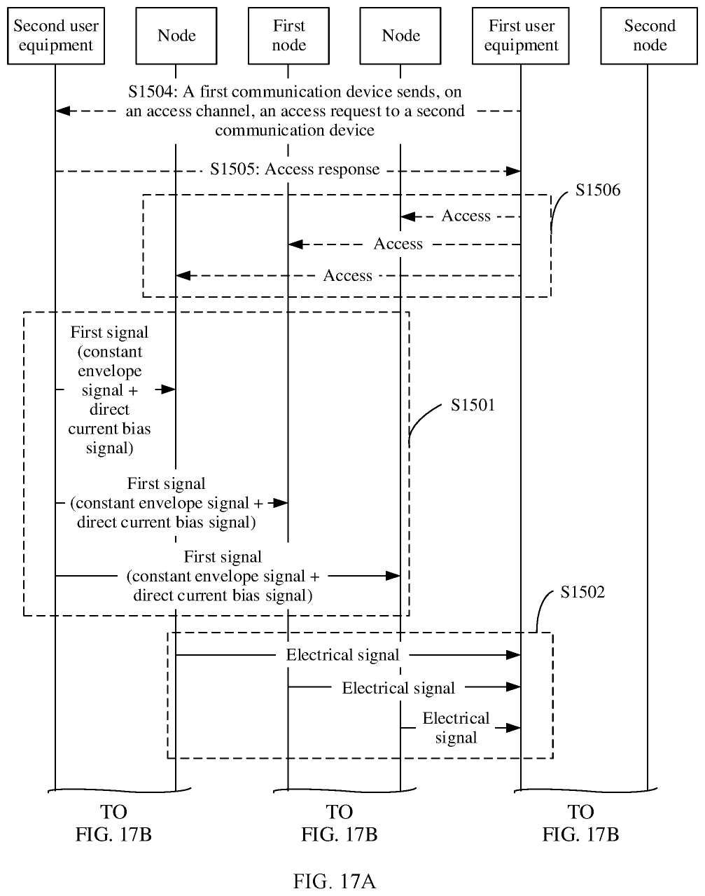

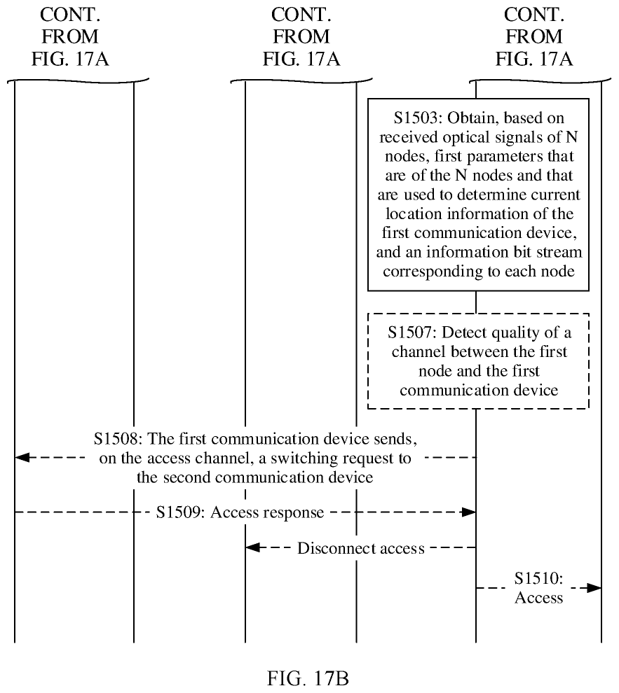

Further, in a process in which the first communication device communicates with the second communication device by using the N nodes, the first communication device may further monitor communication quality of a channel between the first communication device and the node in real time, and switch to another node in time for communication when information quality is poor, to ensure quality of inter-device communication. The process may include steps S1507 to S1510 shown in FIG. 17A and FIG. 17B.

S1507: The first communication device detects quality of a channel between the first node and the first communication device. If it is detected that the quality of the channel between the first node and the first communication device is less than a preset threshold, it indicates that the quality of the channel between the first node and the first communication device is poor, and steps S1508 to S1510 are performed.

The first node is included in the N nodes, and may be any one of the N nodes.

The preset threshold may be set based on a requirement. This is not limited. The quality of the channel between the first node and the first communication device may include an RSS between the first node and the first communication device. For example, the first communication device may obtain, through measurement, that the power attenuation percentage is greater than a specific threshold when positioning the first communication device, and then determine that the quality of the channel between the first node and the first communication device is poor and timely switching needs to be performed.

S1508: The first communication device sends, on the access channel, a switching request to the second communication device. Correspondingly, the second communication device receives the switching request.

For related descriptions of the access channel, refer to the descriptions in S1504. Details are not described again. The switching request may include the current location information of the first communication device and the identifier of the first communication device. The switching request may be used to request to switch from the first node to another node.

It should be understood that the current location information of the first communication device carried in the switching request may be location information of the first communication device when the first communication device initiates switching. For example, the first communication device may determine the current location information of the first communication device with reference to the foregoing RSS-based positioning principle or ALS-based positioning principle, and send the current location information to the second communication device by carrying the current location information in the switching request.

S1509: The second communication device determines, based on the switching request, the second node that can be switched to, and sends a switching response to the first communication device. Correspondingly, the first communication device receives, on the access channel, the switching response from the second communication device.

The switching response includes the identifier of the first communication device and a communication frequency of the second node, and the communication frequency includes the transmit frequency and the receive frequency.

For example, the second communication device may detect nodes around the first communication device, select, from the nodes around the first communication device, the second node that is close to the first communication device and whose channel is idle.

Optionally, after receiving the switching request, the second communication device may reply, to the first communication device, that the switching request is successfully received. Correspondingly, the first communication device receives the reply from the second communication device, and waits for the switching response on the access channel. If the first communication device does not receive a reply from the second communication device within third preset time after sending the switching request, it indicates that the switching request may fail to be sent. In this case, the first communication device resends, on the access channel, the switching request to the second communication device. The third preset time may be set based on a requirement. This is not limited.

Optionally, after receiving the switching response, the first communication device may reply, to the second communication device, that the switching response is received. Optionally, if the second communication device does not receive a reply from the first communication device within fourth preset time after sending the switching response, it indicates that the switching response may fail to be sent. In this case, the second communication device resends, on the access channel, the switching response to the first communication device. The preset time may be set based on a requirement. This is not limited.

Further, after receiving the switching response, the first communication device may detect whether the identifier carried in the switching response is the identifier of the first communication device. If yes, it indicates that the switching response is sent to the first communication device. Further, the first communication device stores a communication frequency of the second node carried in the switching response, to receive, on the receive frequency corresponding to the transmit frequency of the second node and based on the stored communication frequency of the second node, a signal from the second node. On the contrary, if it is detected that the identifier carried in the switching response is not the identifier of the first communication device, the received switching response is discarded.

S1510: The first communication device switches from the first node to the second node (or is understood as disconnecting from the first node and accessing the second node) based on the switching response.

That the first communication device accesses the second node may be understood as that the first communication device establishes a communication connection to each node, for example, switches the communication frequency to a receive frequency corresponding to the node. Subsequently, the first communication device receives signals from a plurality of nodes including the second node through communication connections and with reference to the method shown in FIG. 15, to implement positioning and information bit stream transmission.

Based on the method shown in FIG. 17A and FIG. 17B, when the quality of the channel between the first communication device and the first node is poor, the node can be switched to the second node in time, to ensure communication quality.

The following describes the foregoing method with reference to a scenario shown in FIG. 18. As shown in FIG. 18, there are nine LEDs above UE (that is, a to-be-located object), spatial locations of the nine LEDs do not overlap, and a wavelength of the nine LEDs is 940 nm. Each LED can transmit a positioning/communication signal. A field of view of a single LED is 27°, and the LED is mounted 2.5 meters high from a target device. Nine LEDs are arranged into a 3×3 array, and a distance between LEDs is 0.6 meters. When the to-be-located object moves within a coverage area, the object can always be illuminated by four LEDs at the same time. Positioning/communication signals transmitted by the nine LEDs are single-carrier BPSK signals and transmit frequencies are: 20 MHz, 40 MHz, 60 MHz, 80 MHz, 100 MHZ, 120 MHz, 140 MHz, 160 MHz, and 180 MHz, where a bandwidth is 10 MHz; receive frequencies are: 30 MHz, 50 MHz, 70 MHz, 90 MHz, 110 MHz, 130 MHz, 150 MHz, 170 MHz, and 190 MHz, where the bandwidth is 5 MHz; and BPSK modulation is also used for uplink, a downlink frequency of an access channel is 200 MHz, and an uplink frequency is 210 MHz.

When the UE accesses the nine LEDs, the nine LEDs independently transmit fixed bit streams (for example, 101010 . . . ) on respective transmit frequencies of the nine LEDs. After receiving a group of optical signals transmitted by the LEDs, the UE calculates location information of the UE by referring to an ALS-based positioning principle. The UE sends, on the uplink frequency of the access channel, an access request to a base station. The access request includes an ID of the UE and the location information of the UE. Then, the UE waits for, on the access channel, a reply from the base station. If the reply times out, the UE resends the access request. Then, after receiving the access request from the UE, the base station selects nodes (four LEDs shown in FIG. 18) whose channels are idle and that are close to the UE, and sends, on the downlink frequency of the access channel, an access response that carries the ID of the UE and communication frequencies (for example, the transmit frequencies are 20 MHz, 40 MHz, 60 MHZ, and 80 MHz respectively, and the receive frequencies are 30 MHz, 50 MHZ, 70 MHZ, and 90 MHz respectively) of the four nodes. The UE receives the access response, and after determining that the ID matches the ID of the UE, switches the communication frequency to the communication frequencies corresponding to the four nodes, and sends an uplink ACK signal to the UE, to indicate completion of initial access.

Further, the UE may implement positioning and communication with reference to the process shown in FIG. 15. For example, the UE receives optical signals obtained after constant envelope modulation, direct current bias signal superimposition, and electrical-to-optical conversion are performed on information bit streams transmitted by the four LEDs, and the optical signals are converted into voltage signals after passing through a corresponding PD and TIA. The UE performs sampling and FFT on the voltage signals to obtain spectrums of the signals, and compares center frequencies of the spectrums of the signals with center frequencies of locally stored carriers, determines which LED signals exist, obtains location information of these LEDs, then calculates power attenuation percentages of the signals based on receive powers and transmit powers of the signals and the formula (4), calculates a horizontal distance between the UE and each LED of the four LEDs based on the power attenuation percentages, and then calculates the location information of the UE based on the multilateral positioning method shown in the formula (1). In addition, the signals obtained by performing sampling and FFT on the voltage signals are demodulated to obtain the information bit streams.

Further, the UE continuously measures a location of the UE and quality of a channel between the UE and a currently accessed LED. When finding that signal attenuation of the current LED is greater than a specific value, the UE sends, on the uplink frequency of the access channel, the switching request to the base station, where the switching request includes the ID of the UE and the location information of the UE. Then, the UE waits for, on the access channel, a reply from the base station, and resends the switching request when the reply times out. Then, after receiving the switching request from the UE, the base station selects a node (a node other than the four LEDs connected to the UE shown in FIG. 18) whose channel is idle and that is close to the UE, and sends, on the downlink frequency of the access channel, a switching response carrying the ID of the UE and a communication frequency (for example, a transmit frequency is 100 MHz, and a receive frequency is 110 MHZ) of the node. The UE receives the switching response, and after determining that the ID matches the ID of the UE, switches the communication frequency to the communication frequency corresponding to the node, and sends the uplink ACK signal to the UE, to indicate completion of inter-node switching.

The foregoing uses one first communication device as an example to describe an access process, a positioning process, a communication process, and a switching process of the first communication device. Similarly, another communication device may implement access, positioning, communication, and switching with reference to the foregoing manners.

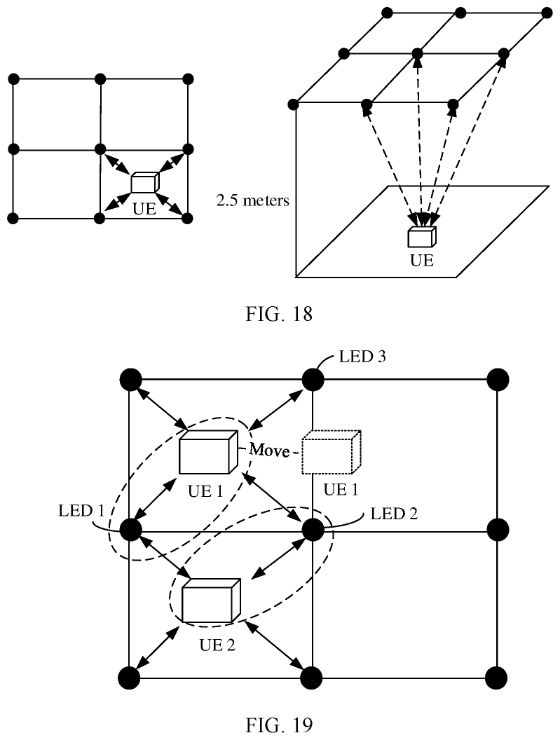

For example, as shown in FIG. 19, there are two communication devices: UE 1 and UE 2. A deployment scenario of the LED in FIG. 19 is the same as that in FIG. 18. When the UE 1 and the UE 2 access nine LEDs, the nine LEDs independently transmit fixed bit streams (for example, 101010 . . . ) on respective transmit frequencies of the nine LEDs. After receiving a group of optical signals transmitted by the LEDs, the UE 1 and the UE 2 calculate location information of the UE 1 and the UE 2 by referring to an ALS-based positioning principle. The UE 1 and the UE 2 send, on an uplink frequency of an access channel in sequence, access requests to a base station. The access requests include IDs of the UEs and the location information of the UEs. Then, the UEs wait for, on the access channel, replies from the base station. If the replies time out, the UEs resend the access requests. Then, after receiving the access requests from the UEs, the base station selects nodes (as shown in FIG. 19, the UE 1 accesses the LED 1, and the UE 2 accesses the LED 2) whose channels are idle and that are close to the UEs, and sends, on a downlink frequency of the access channel, access responses carrying the IDs of the UEs and communication frequencies of the nodes. The UEs receive the access responses, and after determining that the IDs match the IDs of the UEs, switch communication frequencies to the communication frequencies corresponding to the four nodes, and send an uplink ACK signal to the UEs, to indicate completion of initial access.

Further, the UE 1 and the UE 2 may implement positioning and communication with reference to the process shown in FIG. 15. Further, the UE 1 and the UE 2 continuously measure locations of the UE 1 and the UE 2 (the UE 1 moves to the right in parallel, and the UE 2 remains unchanged) and quality of channels between the UE 1 and the UE 2 and a currently accessed LED. When finding that signal attenuation of the current LED is greater than a specific value, the UE 1 sends, on the uplink frequency of the access channel, a switching request to the base station, where the switching request includes the ID of the UE 1 and the location information of the UE 1. Then, the UE 1 waits for, on the access channel, a reply from the base station, and resends the switching request when the reply times out. Then, after receiving the switching request from the UE 1, the base station selects a node (the LED 3 shown in FIG. 19 is selected rather than the LED 2) whose channel is idle and that is close to the UE 1, and sends, on the downlink frequency of the access channel, an access response carrying the ID of the UE 1 and a communication frequency of the LED 3. The UE 1 receives the switching response, and after determining that the ID matches the ID of the UE 1, switches the communication frequency to the communication frequency corresponding to the LED 3, and sends the uplink ACK signal to the UE 1, to indicate completion of inter-node switching.

The foregoing mainly describes the solutions provided in embodiments of this application from a perspective of interaction between network elements. Consequently, an embodiment of this application further provides a communication apparatus. The communication apparatus may be the first communication device in the foregoing method embodiments, an apparatus including the functions of the first communication device, or a component that can be used for the first communication device. It may be understood that, to implement the foregoing functions, the communication apparatus includes a hardware structure and/or a software module for performing a corresponding function. A person skilled in the art should easily be aware that, in combination with units and algorithm steps of the examples described in embodiments disclosed in this specification, this application may be implemented by hardware or a combination of hardware and computer software. Whether a function is performed by hardware or computer software driving hardware depends on particular applications and design constraint conditions of the technical solutions. A person skilled in the art may use different methods to implement the described functions for each particular application, but it should not be considered that the implementation goes beyond the scope of this application.

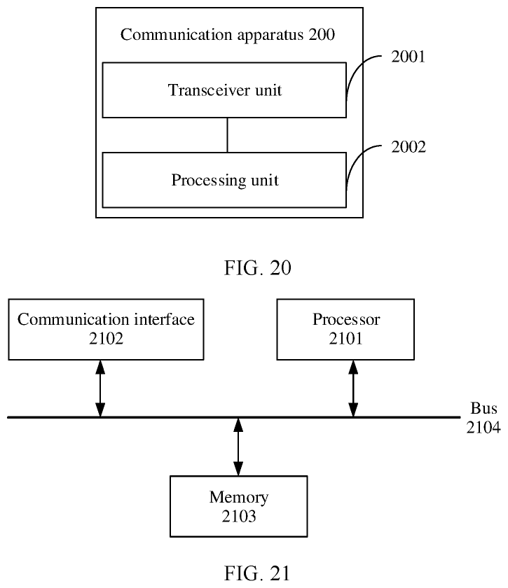

FIG. 20 is a schematic diagram of a communication apparatus 200 according to an embodiment of this application. The communication apparatus 200 includes a transceiver unit 2001 and a processing unit 2002. The processing unit 2002 is configured to implement data processing by the communication apparatus 200. The transceiver unit 2001 is configured to receive content of the communication apparatus 200 and another unit or network element. It should be understood that the processing unit 2002 in this embodiment of this application may be implemented by a processor or a processor-related circuit component (or referred to as a processing circuit), a receiving function of the transceiver unit 2001 may be implemented by a receiver or a receiver-related circuit component, and a sending function of the transceiver unit 2001 may be implemented by a transmitter or a transmitter-related circuit component.

For example, the communication apparatus 200 may be a device of the communication apparatus 200, or may be a chip applied to the device of the communication apparatus 200, or another combined device or component that has a function of the device of the communication apparatus 200. For example, the communication apparatus 200 may be the first communication device in any one of embodiments in FIG. 15 to FIG. 17B.

The transceiver unit 2001 is configured to receive optical signals separately transmitted by N nodes (for example, perform step S1502), where the optical signals are obtained by the nodes by performing electrical-to-optical conversion on first signals, the first signal is a signal obtained by adding a direct current bias signal to a second signal, the second signal is a signal obtained after constant envelope modulation is performed on an information bit stream to be sent by a light source node to the first communication device, frequencies of carriers used by each node to perform constant envelope modulation are different, and N is an integer greater than or equal to 3.

The processing unit 2002 is configured to obtain, based on the received optical signals of the N nodes, first parameters and an information bit stream corresponding to each node (for example, perform step S1503), where the first parameters include horizontal distances d corresponding to the N nodes and location information of each of the N nodes, and the first parameters are used to determine current location information of the first communication device.

Specifically, for an execution process of the transceiver unit 2001 and the processing unit 2002, refer to the execution process of the first communication device in FIG. 15 to FIG. 17B. In addition, the foregoing modules may be further configured to support another process of the technology described in this specification. For beneficial effects, refer to the foregoing descriptions. Details are not described herein again.

FIG. 21 is a schematic diagram of another communication apparatus according to an embodiment of this application. The communication apparatus includes: a processor 2101, a communication interface 2102, and a memory 2103. The processor 2101, the communication interface 2102, and the memory 2103 may be connected to each other through a bus 2104. The bus 2104 may be a peripheral component interconnect (peripheral component interconnect, PCI) bus, an extended industry standard architecture (extended industry standard architecture, EISA) bus, or the like. The bus 2104 may be classified into an address bus, a data bus, a control bus, and the like. For ease of representation, only one line is used for representation in FIG. 21, but this does not mean that there is only one bus or only one type of bus. The processor 2101 may be a central processing unit (central processing unit, CPU), a network processor (network processor, NP), or a combination of the CPU and the NP. The processor may further include a hardware chip. The foregoing hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), a generic array logic (Generic Array Logic, GAL), or any combination thereof. The memory 2103 may be a volatile memory or a nonvolatile memory, or may include both a volatile memory and a nonvolatile memory. The nonvolatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), used as an external cache.

The processor 2101 is configured to obtain, based on received optical signals of N nodes, first parameters and an information bit stream corresponding to each node (for example, perform step S1503), where the first parameters include horizontal distances d corresponding to the N nodes and location information of each of the N nodes, and the first parameters are used to determine current location information of a first communication device. The communication interface 2102 is configured to receive the optical signals separately transmitted by the N nodes (for example, perform step S1502), where the optical signals are obtained by the nodes by performing electrical-to-optical conversion on first signals, the first signal is a signal obtained by adding a direct current bias signal to a second signal, the second signal is a signal obtained after constant envelope modulation is performed on an information bit stream to be sent by a light source node to the first communication device, frequencies of carriers used by each node to perform constant envelope modulation are different, and N is an integer greater than or equal to 3. In addition, the foregoing modules may be further configured to support another process of the technology described in this specification. For beneficial effects, refer to the foregoing descriptions. Details are not described herein again.

An embodiment of this application further provides a communication system, including the foregoing first communication device, the N nodes, and the second communication device. The first communication device performs the methods performed by the first communication device in embodiments shown in FIG. 15 to FIG. 17B.

An embodiment of this application further provides a computer-readable storage medium. The computer-readable storage medium stores a computer program. When the computer program is executed by a computer, the computer may implement a procedure related to the first communication device in any one of embodiments shown in FIG. 15 to FIG. 17B provided in the foregoing method embodiments.

An embodiment of this application further provides a computer program product. The computer program product is configured to store a computer program. When the computer program is executed by a computer, the computer may implement a procedure related to the first communication device in any one of embodiments shown in FIG. 15 to FIG. 17B provided in the foregoing method embodiments.

This application further provides a chip, including a processor. The processor is configured to read and run a computer program stored in a memory, to perform a corresponding operation and/or procedure performed by the first communication device in the optical communication method provided in this application. Optionally, the chip further includes a memory, the memory and the processor are connected to the memory over a circuit or a wire, and the processor is configured to read and execute a computer program in the memory. Further, optionally, the chip further includes a communication interface, and the processor is connected to the communication interface. The communication interface is configured to receive data and/or information to be processed, and the processor obtains the data and/or information from the communication interface and processes the data and/or information. The communication interface may be an input/output interface, an interface circuit, an output circuit, an input circuit, a pin, a related circuit, or the like on the chip. The processor may also be embodied as a processing circuit or a logic circuit.

The chip may alternatively be replaced with a chip system. Details are not described herein again.

The terms “include”, “contain” and any other variants thereof in this application are intended to cover non-exclusive inclusion. For example, a process, method, system, product, or device that includes a series of steps or units are not limited to those steps or units that are clearly listed, but may include other steps or units that are not explicitly listed or are inherent to such a process, method, system, product, or device.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual conditions to achieve the objectives of the solutions in embodiments.

In addition, function units in embodiments of this application may be integrated into one processing unit, or each of the units may exist alone physically, or two or more units may be integrated into one unit.

When the functions are implemented in the form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, or a network device) to perform all or some of the steps of the methods described in embodiments of this application. The foregoing storage medium includes any medium that can store program code, like a USB flash drive, a removable hard disk, a read-only memory (read-only memory, ROM), a random access memory (random access memory, RAM), a magnetic disk, or an optical disc.

In addition, the terms “first”, “second”, and the like in the specification, claims, and accompanying drawings of this application are intended to distinguish between different objects, but are not intended to describe a specific order. In addition, the terms “including” and “having” and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

Although this application is described with reference to specific features and embodiments thereof, it is clear that various modifications and combinations may be made to them without departing from the spirit and scope of this application. Correspondingly, the specification and accompanying drawings are merely example description of this application defined by the accompanying claims, and are considered as any of or all modifications, variations, combinations or equivalents that cover the scope of this application. Clearly, a person skilled in the art can make various modifications and variations to this application without departing from the spirit and scope of this application. This application is intended to cover these modifications and variations of this application provided that they fall within the scope of protection defined by the following claims and their equivalent technologies. The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

1. An optical wireless communication method, wherein the method comprises:
receiving, by a first communication device, optical signals separately transmitted by N nodes, wherein the optical signals are obtained by the N nodes by performing electrical-to-optical conversion on a first signal, the first signal is a signal obtained by adding a direct current bias signal to a second signal, the second signal is a signal obtained after constant envelope modulation is performed on an information bit stream to be sent by a light source node to the first communication device, different nodes correspond to different frequencies of carriers used for constant envelope modulation, and N is an integer greater than or equal to 3; and
obtaining, by the first communication device based on the received optical signals of the N nodes, a first parameter of each node of the N nodes and an information bit stream corresponding to each node of the N nodes, wherein the first parameter comprises a horizontal distance between the node and the first communication device and location information of the node, and N first parameters of the N nodes are used to determine current location information of the first communication device.

2. The method according to claim 1, wherein for a first node of the N nodes, obtaining, by the first communication device, the first parameter of the first node and the information bit stream corresponding to the first node comprises:
performing, by the first communication device, optical-to-electrical conversion processing on a received first optical signal to obtain a third signal, wherein the third signal is a signal obtained after the first signal is transmitted through a channel, and the first optical signal is any optical signal received by the first communication device;
comparing, by the first communication device, a center frequency of a spectrum of the third signal with a center frequency of a carrier corresponding to each node of the N nodes;
if the center frequency of the spectrum of the third signal is the same as a center frequency of a carrier corresponding to the first node, determining that the first optical signal from the first node is received;
determining, by the first communication device, a power attenuation percentage based on a receive power of the third signal and a transmit power used when the first node transmits the optical signal;
determining, by the first communication device, the horizontal distance between the first communication device and the first node based on the power attenuation percentage; and
obtaining, by the first communication device, the location information of the first node according to a stored correspondence between a node and location information of the node.

3. The method according to claim 1, wherein the receiving, by a first communication device, optical signals separately transmitted by N nodes comprises:
receiving, by the first communication device on receive frequencies of the N nodes, the optical signals transmitted by the N nodes, wherein receive frequencies of different nodes are different from each other.

4. The method according to claim 1, wherein the method further comprises:
sending, by the first communication device on an access channel, an access request to a second communication device, wherein the access request comprises the current location information of the first communication device and an identifier of the first communication device;
receiving, by the first communication device on the access channel, an access response from the second communication device, wherein the access response comprises the identifier of the first communication device and a communication frequency of each node of the N nodes, and the communication frequency comprises a transmit frequency and a receive frequency; and
accessing, by the first communication device, the N nodes in response to the access response.

5. The method according to claim 4, wherein the method further comprises:
receiving, by the first communication device on the access channel, fixed bit streams from M nodes; and
determining the current location information of the first communication device based on the fixed bit streams of the M nodes, wherein M is an integer greater than or equal to 3.

6. The method according to claim 5, wherein the N nodes are nodes that are close to the first communication device and whose channels are idle in a plurality of nodes around the first communication device.

7. The method according to claim 1, wherein the method further comprises:
detecting, by the first communication device, that quality of a channel between a first node and the first communication device is lower than a preset threshold, wherein the first node is comprised in the N nodes;
sending, by the first communication device on an access channel, a switching request to a second communication device, wherein the switching request comprises the current location information of the first communication device and an identifier of the first communication device;
receiving, by the first communication device on the access channel, a switching response from the second communication device, wherein the switching response comprises the identifier of the first communication device and a communication frequency of a second node, and the communication frequency comprises a transmit frequency and a receive frequency; and
switching, by the first communication device, from the first node to the second node based on the switching response.

8. The method according to claim 7, wherein the second node is a node that is close to the first communication device and whose channel is idle in a plurality of nodes around the first communication device.

9. A communication device, wherein the communication device is a first communication device and comprises:
a transceiver, the transceiver configured to receive optical signals separately transmitted by N nodes, wherein the optical signals are obtained by the N nodes by performing electrical-to-optical conversion on a first signal, the first signal is a signal obtained by adding a direct current bias signal to a second signal, the second signal is a signal obtained after constant envelope modulation is performed on an information bit stream to be sent by a light source node to the first communication device, different nodes correspond to different frequencies of carriers used for constant envelope modulation, and Nis an integer greater than or equal to 3;
at least one processor; and
at least one memory coupled to the at least one processor and storing programming instructions for execution by the at least one processor to obtain, based on the received optical signals of the N nodes, a first parameter of each node of the N nodes and an information bit stream corresponding to each node of the N nodes, wherein the first parameter comprises a horizontal distance between the node and the first communication device and location information of the node, and first parameters of the N nodes are used to determine current location information of the first communication device.

10. The communication device according to claim 9, wherein for a first node of the N nodes, the programming instructions are for execution by the at least one processor to:
perform optical-to-electrical conversion processing on a received first optical signal to obtain a third signal, wherein the third signal is a signal obtained after the first signal is transmitted through a channel, and the first optical signal is any optical signal received by the first communication device;
compare a center frequency of a spectrum of the third signal with a center frequency of a carrier corresponding to each node of the N nodes;
if the center frequency of the spectrum of the third signal is the same as a center frequency of a carrier corresponding to the first node, determine that the first optical signal from the first node is received;
determine a power attenuation percentage based on a receive power of the third signal and a transmit power used when the first node transmits the optical signal;
determine the horizontal distance between the first communication device and the first node based on the power attenuation percentage; and
obtain the location information of the first node according to a stored correspondence between a node and location information of the node.

11. The communication device according to claim 9, wherein the transceiver is configured to receive, on receive frequencies of the N nodes, the optical signals transmitted by the N nodes, and wherein receive frequencies of different nodes are different from each other.

12. The communication device according to claim 9, wherein:
the transceiver is further configured to send, on an access channel, an access request to a second communication device, wherein the access request comprises the current location information of the first communication device and an identifier of the first communication device;
the transceiver is further configured to receive, on the access channel, an access response from the second communication device, wherein the access response comprises the identifier of the first communication device and a communication frequency of each node of the N nodes, and the communication frequency comprises a transmit frequency and a receive frequency; and
the programming instructions are for execution by the at least one processor to access the N nodes in response to the access response.

13. The communication device according to claim 12, wherein:
the transceiver is further configured to receive, on the access channel, fixed bit streams from M nodes; and
the programming instructions are for execution by the at least one processor to determine the current location information of the first communication device based on the fixed bit streams of the M nodes, wherein Mis an integer greater than or equal to 3.

14. The communication device according to claim 13, wherein the N nodes are nodes that are close to the first communication device and whose channels are idle in a plurality of nodes around the first communication device.

15. The communication device according to claim 9, wherein:
the programming instructions are for execution by the at least one processor to detect that quality of a channel between a first node and the first communication device is lower than a preset threshold, wherein the first node is comprised in the N nodes;
the transceiver is configured to send, on an access channel, a switching request to a second communication device, wherein the switching request comprises the current location information of the first communication device and an identifier of the first communication device;
the transceiver is further configured to receive, on the access channel, a switching response from the second communication device, wherein the switching response comprises the identifier of the first communication device and a communication frequency of a second node, and the communication frequency comprises a transmit frequency and a receive frequency; and
the programming instructions are for execution by the at least one processor to switch from the first node to the second node based on the switching response.

16. The communication device according to claim 15, wherein the second node is a node that is close to the first communication device and whose channel is idle in a plurality of nodes around the first communication device.

17. A communication system, comprising:
a first communication device, N nodes, and a second communication device, wherein Nis an integer greater than or equal to 3;
wherein the first communication device is configured to receive optical signals separately transmitted by the N nodes, wherein the optical signals are obtained by the N nodes by performing electrical-to-optical conversion on a first signal, the first signal is a signal obtained by adding a direct current bias signal to a second signal, the second signal is a signal obtained after constant envelope modulation is performed on an information bit stream to be sent by a light source node to the first communication device, frequencies of carriers used by each node to perform constant envelope modulation are different, and N is an integer greater than or equal to 3; and
wherein the first communication device is further configured to obtain, based on the received optical signals of the N nodes, a first parameter of each node of the N nodes and an information bit stream corresponding to each node of the N nodes, wherein the first parameter comprises a horizontal distance between the node and the first communication device and location information of the node, and N first parameters of the N nodes are used to determine current location information of the first communication device.

18. The communication system according to claim 17, wherein the first communication device is configured to receive the optical signals on receive frequencies of the N nodes, and receive frequencies of different nodes are different from each other.

19. The communication system according to claim 17, wherein the first communication device is configured to send, on an access channel, an access request to the second communication device, and wherein the access request comprises the current location information of the first communication device and an identifier of the first communication device.

20. The communication system according to claim 19, wherein the first communication device is configured to:
receive, on the access channel, an access response from the second communication device, wherein the access response comprises the identifier of the first communication device and a communication frequency of each node of the N nodes, and the communication frequency comprises a transmit frequency and a receive frequency; and
access the N nodes in response to the access response.
